(19) United States
(12) Patent Application Publication
(10) Pub. No.: US 2002/0061270 A1
(43) Pub. Date: May 23, 2002

(54) Method and apparatus for wet gas scrubbing

(76) Inventor: Gerard W. Osborne, Alpharetta, GA (US)

Correspondence Address: Lisa J. Moyles, KILPATRICK STOCKTON LLP, 2400 Monarch Tower, 3424 Peachtree Road, N.E., Atlanta, GA, 30326, US

(21) Appl. No.: 09/870,928

(22) Filed: May 30, 2001

Related U.S. Application Data
(60) Provisional application No. 60/207,774, filed on May 30, 2000.

(51) Int. Cl. B01D 53/34; B01J 19/00

(52) U.S. Cl. 423/210; 423/567.1; 422/171; 422/172

(57) ABSTRACT

Remediation of gases is accomplished by intimately mixing the products of combustion with a minute quantity of ozone to convert pollutants to highly soluble compounds. The resulting gas mixture is then reduced in temperature and the problematic gas constituents are placed into solution. This is accomplished through the use of one or more water spray towers, placed in series with the gas flow. The clean gas is released. The contaminated water is remediated by water treatment methods and apparatuses, such as those employing the CBR Patents.

### CROSS REFERENCE APPLICATION

This patent application claims the benefit of the earlier filed Provisional Patent Application Ser. No. 60/207,774 filed May 30, 2000 which is herein incorporated in its entirety.

### FIELD OF THE INVENTION

The present invention relates to apparatuses and methods for remediation of gases. More particularly, the invention relates to wet gas scrubbers which employ ozone for removing gaseous pollutants from stationary power sources

### BACKGROUND OF THE INVENTION

Recently adopted emission standards from government agencies require power plants to further decrease emissions from their stacks for a range of pollutants, including various forms of nitrous oxide compounds (NOX) and sulfur oxide compounds (SOX) as defined by the Environmental Protection Agency (EPA).

Methods for reducing NOX emissions, practiced since the late 1960's include 1.) modifications to fuel combustion processes, thereby reducing the formation of thermal NOX, 2.) the use of selective non-catalytic reduction (SNCR) and 3.) the application of selective catalytic reduction (SCR). Methods 2.) and 3.) are designed to treat the thermal NOX, following formation in the combustion chamber, by using a combination of chemicals, such as urea and ammonia and/or catalysts to convert or partially remove the nitrogen oxide compounds. Each of these three methods is discussed below.

1. Combustion Modifications

The approaches being used for the reduction of NOX emissions through modifications to the combustion processes, may be further described by:

a.) Low excess air operation, which is typically, defined as less than 5 to 10% excess air;

b.) Staged combustion with very low or sub-stoichiometric combustion at the burners, followed by air injection in one (1) or more stages downstream;

c.) Gas recirculation through the burners or through multiple ports located in the burner zone and elsewhere in the furnace chamber. This may also be used with a.) or b.) above;

d.) Dual register or multiple air register burners, that are intended to create zones of combustion with different excess air levels, but generally starting with low sub-stoichiometric combustion toward the center (fuel source), and progressively leading toward greater air-rich zones, as the distance from the burner centerline is increased;

e.) Increased burner spacing and significantly increased furnace volumes, particularly in lower elevations of a steam generator or boiler. This tends to provide more furnace heat transfer surface that assists in cooling the flame temperature, resulting in lower thermal NOX formation; and

f.) Use of bubbling or circulating fluid-bed combustors that operate with significantly lower furnace temperatures, yielding lower thermal NOX formation.

There are a number of limitations or drawbacks with these process modifications, which include:

Reduced combustion and boiler efficiency, due to incomplete combustion or LOI (Loss of Ignition);

Reduced boiler efficiency, resulting from lower temperature differentials, which yield lower heat transfer rates for comparable heating surfaces;

Increased capital cost for new plant construction, as a consequence of larger heat transfer surface requirements; both from increased furnace sizing, larger superheater and reheater requirements; larger burner and burner windboxes; installation of gas recirculation flues, fans, and fan motors; increased air and gas-side design pressures, due to larger forced draft fan static pressures; and

Higher maintenance costs from furnace tube metal wastage from low excess air operation in the burner zone.

An additional disadvantage of these modifications is that they do not help to reduce SOX emissions.

2. Selective Non-Catalytic Reduction (SNCR)

This process typically injects ammonia and/or urea compounds into the combustion gas stream to assist in the breakdown of NOX compounds. SNCR systems are intended to obtain small improvements in the NOX emissions in combustion gases.

Adequate mixing volume, residence time, and correct gas temperature levels are needed to obtain the desired results. This method has been generally restricted to existing installation, where NOX reductions are desired, but where service and cost considerations preclude the use of the combustion modifications described above or SCR as described in more detail below.

This process also has no impact on emissions from SOX compounds.

3 Selective Catalytic Reduction (SCR)

This process utilizes various types of catalysts, which are positioned within the gas stream, at predetermined temperature ranges. These systems operate in much the same way as catalytic converters in automobiles, and are very effective for clean natural gas fuels. When firing heavy oil, their performance decreases while maintenance costs increase.

The catalysts have fairly significant initial costs, with catalyst replacements and maintenance costing several millions of dollars per year, including recycling and cleaning of the catalysts. Ultimately, the catalysts must be disposed of in hazardous waste disposal sites.

This process likewise has no impact on emissions from SOX compounds.

Wet And Dry Scrubbers

For reduction of SOX compounds, there are two (2) methods that have been commercially used over the past twenty-five (25) years: dry scrubbers and wet scrubbers.

Wet scrubbers operate by injecting a lime slurry into the gas stream at the inlet of a scrubber vessel or tank, as well as along the walls to obtain intimate contact between the lime and the SOX compounds in the gas stream.

The SOX compounds react with the lime to convert the SOX to Calcium Sulfate sludges, which must be removed and disposed of, either by landfill or by converting to wallboard.

Lime or limestone consumption is fairly high, as are capital, operating, and maintenance costs.

Dry scrubbers also use lime slurry, but it requires injection into specific gas temperature zones within the combustion chamber. This requires design modifications of the combustion process, including the use of fluid bed-type boilers.

Initial capital costs are high, but not as high as for wet scrubbers. However, the system efficiency is lower for dry scrubbers.

All of the above-described types of equipment for emission reduction have tended to increase operating costs of power plants by 20% to 30%, not to mention the increase capital investment required.

What is needed are less expensive apparatuses and methods for generating power that release fewer emissions, efficiently generate power, use less resources, produce less waste during combustion, and do not produce particulates that damage equipment.

Aside from employing more expensive equipment to meet emission standards, power plants have changed combustion materials. For example, some power plants were built near large reserves of high sulfur coal, an efficiently burning type of coal having a high BTU heating value. However, this type of coal releases more emissions than allowed by the recent government regulations. Therefore, these companies have switched to a type of coal having a lower heating value, higher moisture content, that is difficult to burn and is less efficient. An additional disadvantage is that this fuel must be shipped from areas remote from the power plant, thus wasting more resources and farther increasing operating costs. Furthermore, different equipment is needed to burn the less efficient type of coal, which may be 2.5 times more expensive than the equipment used to burn the high sulfur coal.

U.S. Pat. No. 4,212,654 to Caraway describes a centrifugal wet gas scrubbing method and apparatus. This patent discloses a method of uniformly saturating the gas to be scrubbed with water vapor to a relative humidity of substantially 100%, and then centrifugally compressing the wetted gas by many atmospheres to condense and extract the particulates and contaminants contacted by the water vapor.

U.S. Pat. No. 4,286,973 to Hamlin et al. describes a wet gas scrubbing method and apparatus. This patent discloses a method of contacting the gases with a multiplicity of water sprays in a duct leading to cyclone separators and the gases are further sprayed with water within the cyclones, the cyclones separating the gases from the particulate material which is flushed from the cyclone by spraying water on the inner surface of the cyclone.

U.S. Pat. No. 5,639,434 to Patrikainen et al. describes a gas scrubbing method and apparatus for use in conjunction with a pulp mill. This patent discloses a method of feeding flue gases an oxidizing agent, such as chlorine dioxide or ozone, transferring the gases to the scrubber and adding a reagent (alkali metals) coming from the circulation of chemical of the pulp mill. The flue gas containing nitrogen is led out of the scrubber and the oxidized reagent is led back to the circulation of chemicals of the pulp mill. Waste-byproducts are produced, disposal of which is a problem.

U.S. Pat. No. 6,063,348 to Hinke et al. describes a gas scrubbing method and apparatus. This patent discloses a method of adding phosphorous (P4) in water liquid/liquid emulsion to a flue gas having a temperature of about 180° C. to about 280° C. to induce phosphorus-accelerated oxidation of the NO in the flue gas. Waste-byproducts are produced, disposal of which is a problem.

What is needed are far less expensive apparatuses and methods for utilizing local high-energy fuel, which release fewer emissions and do not produce waste by-products.

### SUMMARY OF THE INVENTION

Less expensive apparatuses and methods for use with power generators that release fewer emissions than currently used apparatuses and methods, that allow for efficient generation of power, allow the use of high-energy fuel and less raw material, produce less waste, and do not produce particulates that damage equipment are described herein.

The present invention permits the scrubbing of the products of combustion in a single system without the additional lime, limestone, ammonia, or catalysts, and while generating extremely small quantities of waste, in the form of relatively pure sulfur, plus clean nitrogen gas. Furthermore, this process does not require that combustion efficiencies be reduced to achieve low NOX emissions, nor that low sulfur coal be burned to achieve low SOX emissions.

In the present invention, the products of combustion are mixed with a minute quantity of ozone, which then convert the NOX and SOX pollutants to highly soluble compounds, in the presence of water at atmospheric pressure. The resulting gas mixture is reduced in temperature through this process, and the problematic gas constituents go into solution. This is accomplished through the use of one or more water spray towers placed in series with the gas flow.

In addition to NOX and SOX pollutants, other pollutants such as Carbon Monoxide (CO), Carbon Dioxide (CO₂), Volatile Organic Compounds (VOC), and particulates containing heavy metals, such as mercury, are also simultaneously removed from the combustion gas stream.

The combustion gas stream, cleansed of pollutants, is then discharged to the atmosphere, through the stack, while the pollutants remain in solution for subsequent treatment and removal by other systems, such as the Centrifugal Bioreactor (CBR), U.S. Pat. Nos. 5,622,819 and 5,821,116 and U.S. Pat. Ser. No. 09/115,109, now U.S. Pat. No. 6,133,019, and the Biofilm Omega Zero process, U.S. Pat. Ser. No. 09/224,645, now U.S. Pat. No. 6,214,617, and U.S. Pat. Ser. No. 09/316,566, PCT Patent Application No. PCT/US99/11305, and the CBR 2001 Centrifugal Bioreactor, U.S. Pat. Ser. No. 60/179,273, each of which is incorporated herein by reference in its entirety. These patents and patent applications are referred to hereafter as “CBR patents.”

Accordingly, it is an object of the present invention to provide novel apparatuses and methods for releasing fewer emissions than currently used apparatuses and methods.

It is yet another object of the present invention to provide novel apparatuses and methods that allows use of more efficiently generated power without increasing emissions.

It is yet another object of the present invention to provide novel apparatuses and methods for employing high-energy fuel while generating lower amounts of emissions than are released by currently available technologies.

It is yet another object of the present invention to provide apparatuses and methods for using fewer raw resources than are used by currently available technologies.

It is yet another object of the present invention to provide apparatuses and methods that reduce existing particulates from coal or oil fuel, and do not further increase particulates from lime, limestone, and catalysts, that may further damage equipment, or the environment.

It is yet another object of the present invention to provide apparatuses and methods for producing less waste than are generated by currently available technologies.

It is yet another object of the present invention to provide apparatuses and methods that are less expensive to purchase and operate than are currently used apparatuses and methods.

These and other objects, features and advantages of the present invention will become apparent, after a review of the following detailed description of the disclosed embodiments and appended claims.

### BRIEF DESCRIPTION OF THE FIGURES

FIG. 1 is a block flow diagram showing the chemical reactions and general process flow for remediating gases with the method of the present invention.

FIG. 2 is a process diagram that identifies the specific components involved in the implementation of the method of FIG. 1.

FIG. 3 illustrates plans and cross-sectional views of a typical lab-scale reaction chamber and scrubber system according to one aspect of the present invention.

FIG. 4 illustrates typical plans and cross-sectional views of a large-scale system for a 273 MW electric power plant.

FIG. 5 is a schematic of a reaction chamber according to one aspect of the present invention for converting NOX and SOX components in the combustion gases to more soluble forms.

FIG. 6 is a process diagram of a typical scrubber system for placing the converted NOX and SOX components into an aqueous solution.

FIG. 7 is a graph illustrating the influence on NOX emissions from only spray water.

FIG. 8 is a graph illustrating the influence on NOX emissions from varying levels of spray water and ozone to the tower of the reaction chamber of FIG. 5.

FIG. 9 is a graph showing the reduction of NOX emissions from gases released by an 800 watt generator, as related to injection points in the invention.

FIG. 10 is a graph showing the reduction in NOX emissions from gases released by an 800 watt generator pursuant to residence time, and as a function of the type of raw material used to generate the ozone.

FIG. 11 is a block diagram illustrating three separate water treatment stages, the final phase in the removal of contaminants from exhaust gas in the method of the present invention.

FIG. 12 is a process flow diagram of one type of recycle waste-water treatment system for removing the dilute sulfuric acid formed by the process.

FIG. 13 is a process flow diagram of one type of recycle waste-water treatment system for removing the dilute nitric acid formed by the process.

FIG. 14 is an analysis of the balance of centrifugal forces and flow velocity forces in a rotating conical biocatalyst immobilization chamber.

FIG. 15 is an illustration of a three-dimensional array of particles in a rotating conical biocatalyst immobilization chamber.

FIG. 16 is an analysis of the positional variation of the centrifugal and flow velocity forces in a chamber according to the present invention at a flow rate of 10 mL/min.

FIG. 17 is a block diagram of a process configuration designed to maintain desired dissolved gas concentrations in the liquid input to a centrifugal bioreactor.

FIG. 18 is a sectional view of an embodiment of the Centrifugal Fermentation Process when viewed parallel to the axis of rotation.

FIG. 19 is a view of the rotor body of FIG. 18 when viewed parallel to the axis of rotation.

FIGS. 20a-b are graphical and mathematical representations of the portion of a biocatalyst immobilization chamber which resembles a truncated cone.

FIG. 21 shows one CBR embodiment to generate ethanol by, for example, anaerobic fermentation of glucose to ethanol by an immobilized fermentative yeast population.

FIG. 22 shows one CBR embodiment to generate replacement microbial cells for periodic introduction into a parallel array of biocatalyst immobilization chambers.

FIG. 23 is an embodiment of the present invention wherein the apparatus isolates metals from ores.

FIG. 24 is an embodiment of the present invention wherein the apparatus removes gases.

FIG. 25 is a perspective view of another embodiment of the present invention.

FIG. 26 is a cross-sectional view of the embodiment of FIG. 25.

FIG. 27 is a perspective view of another embodiment of the present invention.

FIG. 28 is a cross-sectional view of the embodiment of FIG. 27.

FIG. 29 is a schematic of an embodiment of the present invention useful for removal of contaminants from fluids.

### DETAILED DESCRIPTION OF THE INVENTION

The present invention provides novel apparatuses and methods for releasing fewer emissions, while efficiently generating power. Power generators using the methods of the present invention are able to employ high-energy fuel, use less raw material resources, and produce less waste, while not producing particulates that may be damaging to equipment and the environment.

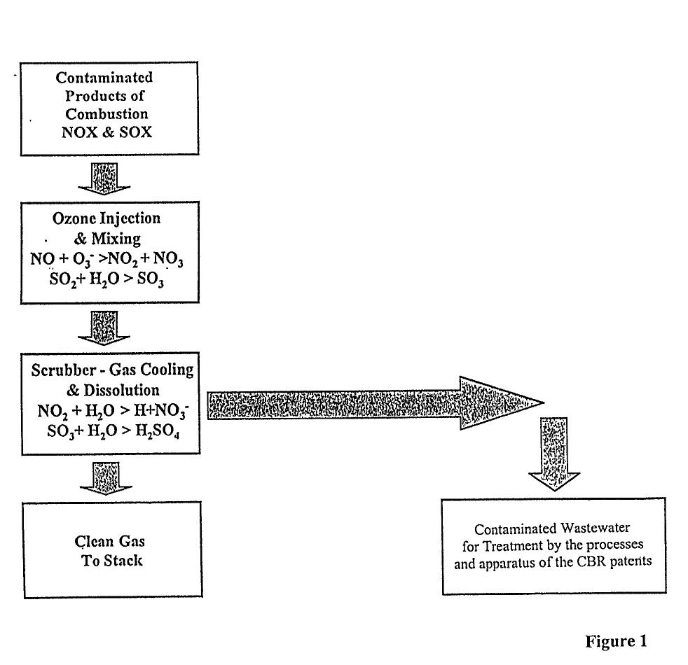

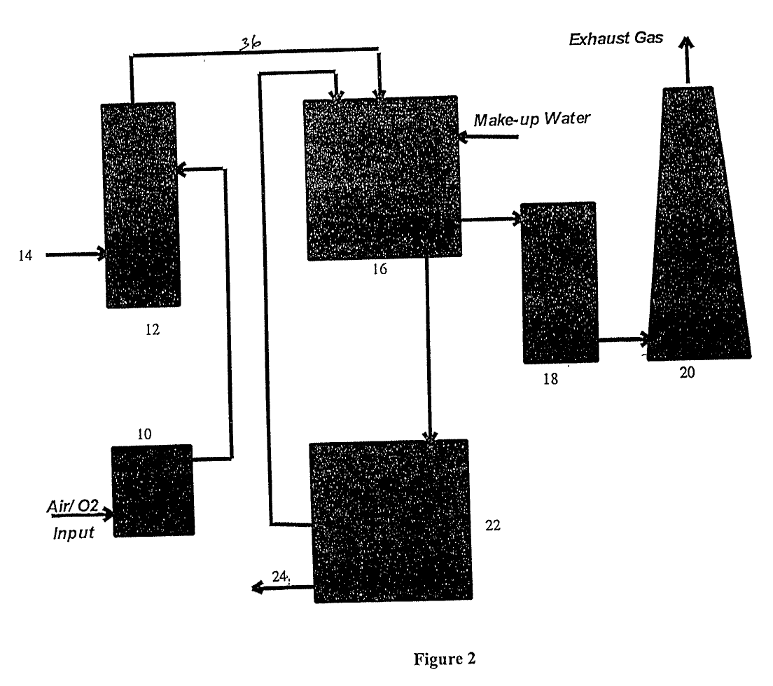

FIG. 1 and FIG. 2 are flow charts illustrating the method of the invention. There are two phases in the method of the present invention: Gas Treatment and Wastewater Treatment.

The general process of the invention is shown in FIG. 1. In the Gas Treatment phase, the products of combustion from power generation are intimately mixed with minute quantities of ozone to convert the pollutants to highly soluble compounds. The resulting gas mixture is then reduced in temperature, all of which causes the problematic gas constituents to easily go into solution in water. This later step is accomplished through the use of one or more water spray towers, placed in parallel or series with the gas flow. The specific positioning of the spray towers will be a function of the specified effluent and operating conditions at each plant site. In the Wastewater Treatment phase, the clean gas is then released to the stack and the contaminated wastewater is sent to an attached water treatment facility. The treated water is then recycled back into the spray tower.

Gas Treatment

FIG. 2 illustrates the method and apparatuses in more detail. In FIG. 2, during the Gas Treatment phase, air is input into the ozone generator 10. The ozone generator is used to inject a relatively minute amount of ozone into a reaction chamber 12, ahead of the scrubber 16. The generation of ozone, in the required quantities, can be provided by a broad range of existing, commercially available equipment. There are presently listed in the Thomas Register over 122 U.S. suppliers for this type of equipment including companies, such as: Osmonics (Minnetonka, Minn.), Hess Machine International (Ephrata, Pa.), Clear Water Tech. Inc. (San Luis Obispo, Calif.), AirSep Corporation (Amherst, N.Y.), and Puregas Corp. (Westminster, Co.).

Compressed air provides the feed to the ozone generator, and is the preferred source, although other commercially known sources may be used. A few advantages of the use of compressed air and ozone are as follows.

Compressed air has a lower cost than oxygen. The use of air, in lieu of oxygen, doesn't require the construction or operation of an oxygen generation plant with its oxygen compressor, simply a standard air compressor. Thereby unnecessary capital investment, increased consumables and labor are avoided.

The use of compressed air also enhances safety. The production and storage of oxygen is inherently more dangerous, compared to the producing and storing of air.

Additionally, ozone produced from oxygen quickly reassociates with available oxygen molecules to actually reduce the available ozone production from the ozone generator.

The quantity of ozone produced by the ozone generator, should be slightly in excess of the quantity of NO and SO₂ compounds in the flue gas. (As used herein, whenever “NO and SO₂” are referenced instead of the generic term “NOX and SOX compounds”, it is because one of ordinary skill in the art will understand that of the NOX and SOX compounds, NO and SO₂ are the most difficult to place into solution. If NO and Sq are placed into solution, the other NOX and SOX compounds will likewise dissolve.) This conversion efficiency will be a function of the physical reactor configuration and the arrangement of the ozone injection nozzles that yield an optimum intimate mixing of the ozone with the flue gas, for the appropriate period of time. A benefit of the apparatus of the present invention is that ozone injection is adjustable. This allows the user to manipulate the ozone to reach maximum results for each individual application.

In FIG. 2, ozone is transferred into reaction chamber 12. Contaminated gases from a power generator are added through inlet 14, and the contaminants are converted into more soluble compounds.

The gases then travel through crossover duct 36 to scrubber 16 where the particulates are placed into solution. The clean gas then travels to reheater 18 where it is heated to a point that it will rise when released from stack 20.

The contaminated water leaves scrubber 16 and is sent to water treatment system 22 for removal of high concentrations of contaminants. The clean water is recirculated back into scrubber 16. Contaminants are removed from the water treatment system 22 by the system blowdown 24.

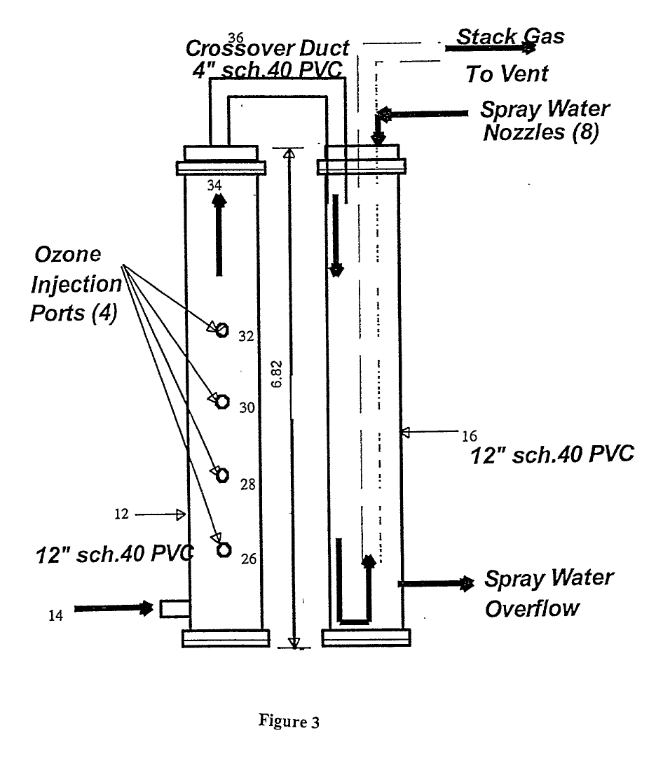

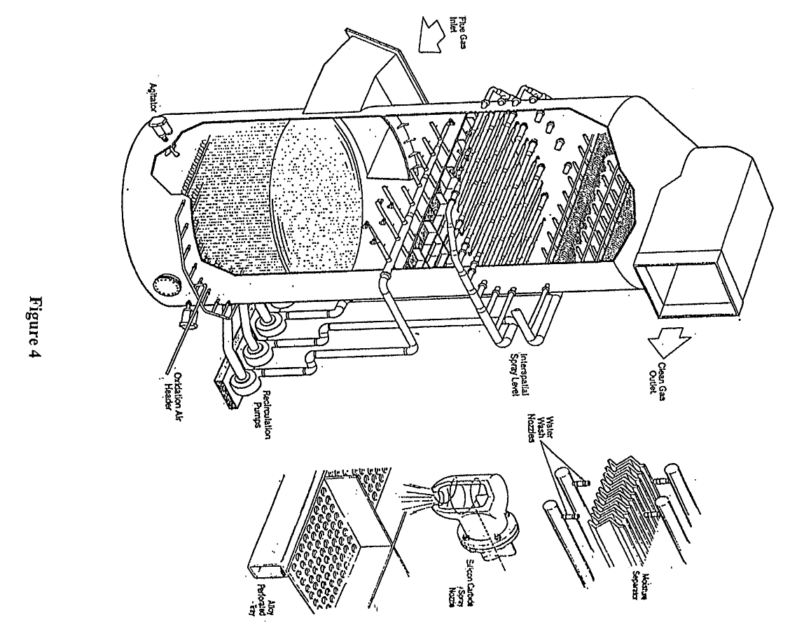

FIGS. 3 and 4 are drawings of embodiments of the apparatus of the invention for removing emissions from the released gases. FIG. 3 is a schematic of the lab-scale system.

FIG. 3 shows exhaust gas inlet 14 into reaction chamber 12. Reaction chamber 12 has several ozone injection ports 26, 28, 30, 32. When exhaust gas enters at inlet 14, ozone injected through port 26 has the highest contact time with the contaminated gas. Contact lasts until the exhaust gas leaves outlet 34. When exhaust gas enters at inlet 14, ozone injected through port 32 has the lowest contact time with the contaminated gas. Contact time from this last port lasts until the exhaust gas leaves outlet 34. Several injection ports are employed for flexibility in modifying the location of ozone injection. This flexibility allows for optimizing the contact time of the ozone with the exhaust gas for maximizing chemical conversion of the contaminants into more soluble compounds.

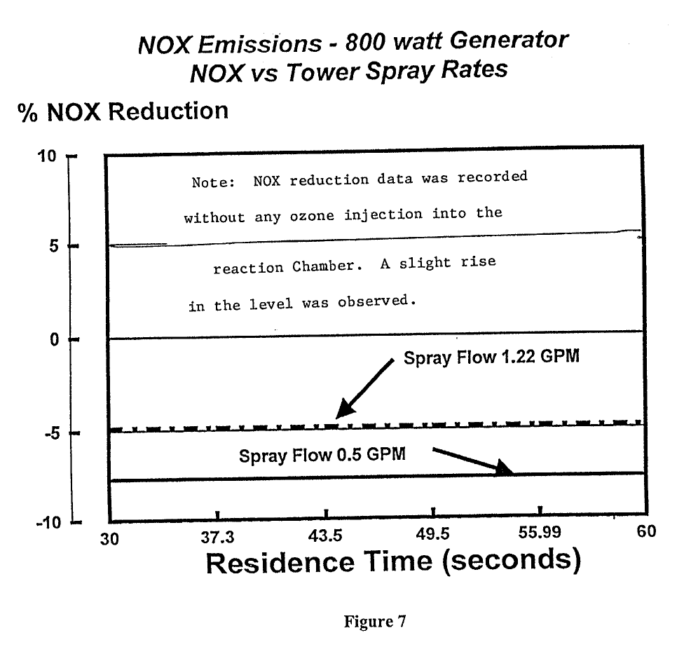

In the lab-scale system, the exhaust gas was then passed through crossover duct 36 and into scrubber 16. The contaminants were removed from the gas and placed into aqueous solution. The gases and waste-water were then tested for contaminants. Results of these tests are described in FIGS. 7-10 below.

FIG. 4 is a schematic of a typical 273 MW power plant and wet scrubber that might be used for this application after the modifications described herein are implemented. Such an apparatus can be supplied by one or more commercial designers and fabricators of such systems. The expected diameter of such a system for a 273 MW coal-fired power plant would be approximately 36 feet in diameter, using a single scrubber module.

Wet scrubbers have been employed commercially since the 1960's, and are currently engineered and constructed by over 100 companies, although large units for coal-fired electric utility applications are produced by approximately 10 U.S. firms. More than 150,000 MW of wet scrubber capacity has been installed over the past 30 years by companies, such as, ABB Flakt (Knoxville, Tenn.), Babcock & Wilcox (Barberton, Ohio), Environmental Elements (Baltimore, Md.), Foster Wheeler Environmental (Clinton, N.J.), Monsanto Envirochem (Chesterfield, Mo.), and Wheelabrator (Pittsburgh, Pa.).

The technology for the design of such systems is well-known and proven. All systems used to date, however, are designed to chemically convert and neutralize SOX, and not to simply place the products of combustion into solution. Nor have they been used to treat NOX components of combustion gases.

In the past, keeping the compounds in solution in the reaction chamber has been a problem. Unless solubility of NO and SO₃ compounds are enhanced, Henry's law then leads to a conclusion that extremely large quantities of water, or extremely high system pressures will be required to keep these compounds in solution. This is indicated by the following “Solubility Constants”:

NO (Nitric Oxide) 0.00517 gms/100 gms.water at 30° C.

N₂O (Nitrous Oxide) 0.1211 gms/100 gms.water at 30° C.

To determine the water quantity in gms. per hour, Henry's Law requires that 1.) the flow rate quantity of each combustion gas constituent be determined in grams or pounds per hour, and 2.) divide item 1.) by the appropriate “Solubility Constant” to arrive at the water volume needed.

NO has a solubility that is 20 times lower than N₂O. By converting NO compound to N₂O or NO₂, the enhanced solubility permits the practical application of a combustion gas scrubbing device to place these compounds into solution.

This is possible by placing NO in contact with ozone, which is what occurs naturally, during a thunderstorm. Lightening discharged during a thunderstorm creates ozone. That ozone comes into contact with NO, converting it to more soluble compounds, that are then placed into solution by intimate contact with rain. This helps to explain the phenomena called “acid rain.” Similarly, this reaction also occurs with SOX compounds, which enhances their solubility in water.

Our testing has confirmed that these conditions can be economically duplicated using our apparatus, to cause this chemical change in NOX and SOX compounds, thus significantly reducing the volume of water required to place the resulting compounds into solution.

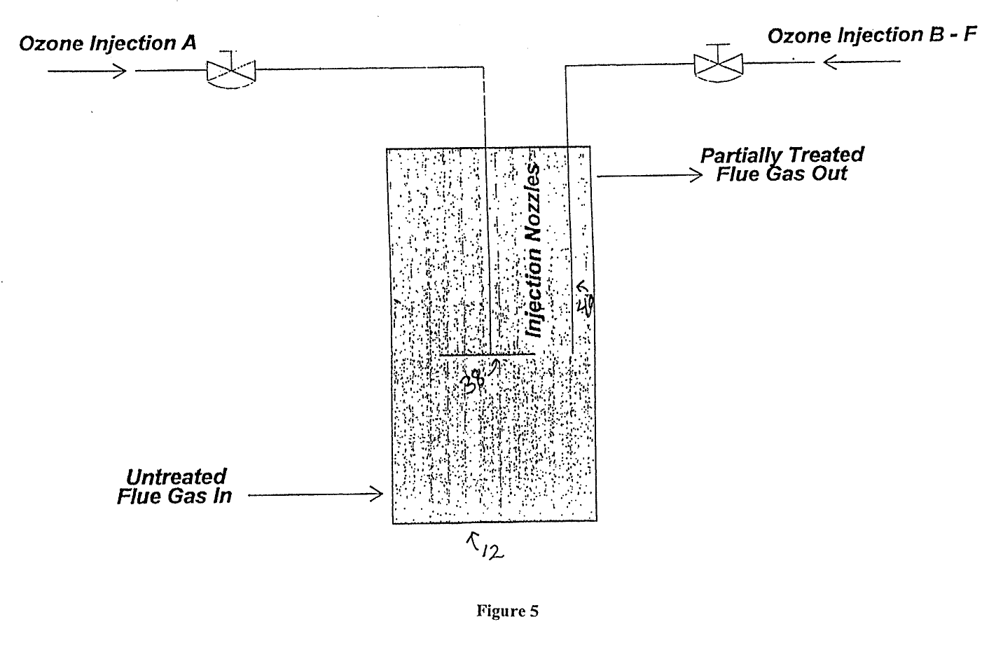

FIG. 5 illustrates the versatility of a reaction chamber 12 of the present invention for mixing the combustion gas (products of combustion using fossil fuel and air). Reaction chambers 12 may vary in size, depending on the 1.) overall combustion gas flow, 2.) gas temperature, 3.) NOX levels, and 4.) SOX levels. All of these factors combine to establish the proper residence time for the chemical reaction to occur, which is in the range of 30 to 50 seconds. In one embodiment, injection nozzles may be placed at varying heights in the interior 38 of the chamber 12. Alternatively, injection nozzles may be placed on the side 40 of the chamber 12, also at varying heights.

It is also possible that the flues or gas ducts connecting an electrostatic precipitator (preceding the reaction chamber 12 or scrubber 16) could be used as the reaction chamber 12. In this approach, the injection nozzles could be inserted into such flue work to cause the conversion of the NOX and SOX constituents into more soluble gaseous components.

The formulas for ozone injection and mixing in the reaction chamber 12 are as follows:

NO+O₃>NO₂+NO₃

SO₂+O>SO₃

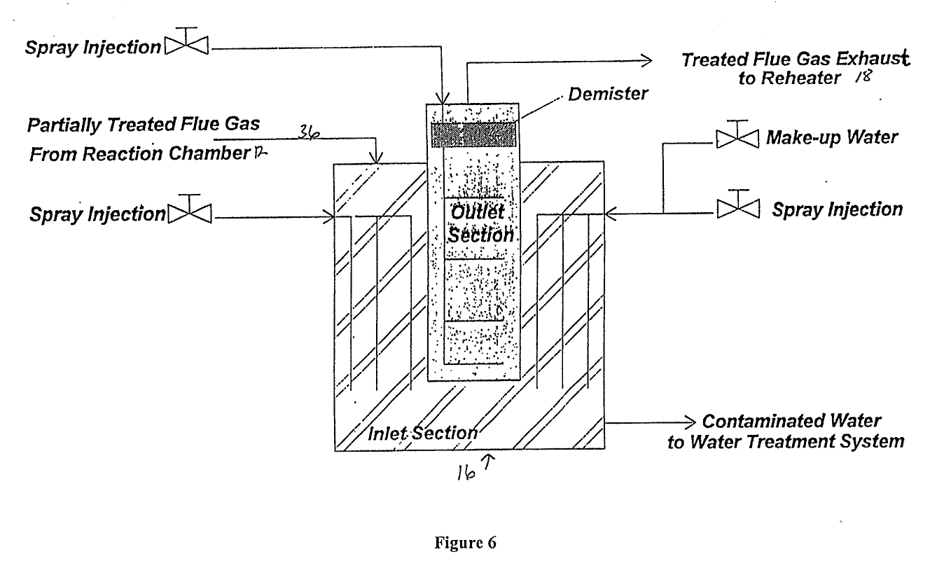

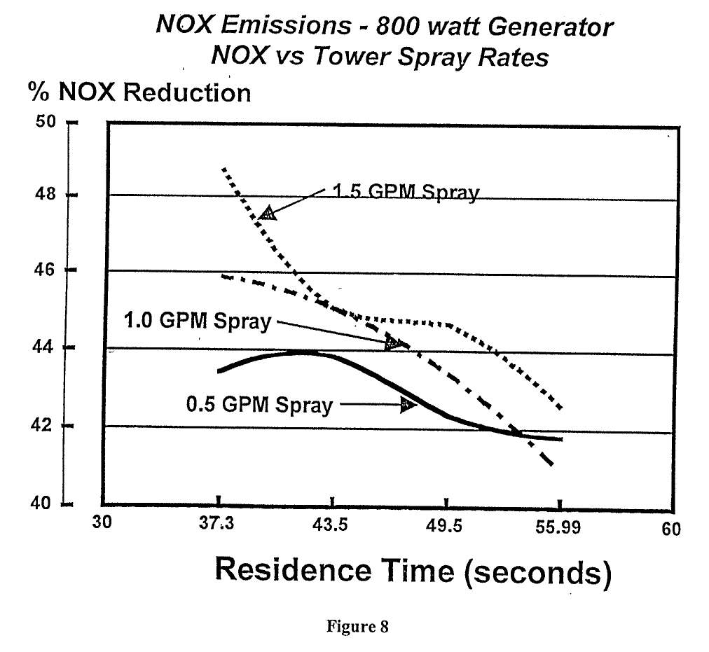

(The symbol “>” as used herein means “yields.”) Upon conversion of the insoluble NOX and SOX compounds to more soluble forms in the reaction chamber 12, the combustion gas is quenched with a water spray in the water spray towers of the scrubber 16 as illustrated in FIG. 6. The results of contaminant reduction are shown in FIGS. 8-10, described below. Here, polluted gases, previously mixed with ozone, are then exposed to finely atomized water in the scrubber, which both reduces the temperature of the gas to enhance solubility, and places the NOX and SOX components into solution.

Unlike commercial versions of flue gas scrubbers used today, the only purpose of this scrubber 16, is to 1.) reduce the gas temperature to approximately 100 to 120° F. (37.8 to 48.9° C.), and 2.) to place the NOX and SOX compounds into a aqueous liquid solution. Unlike current commercial SOX scrubbers, the NO-SOX scrubber 16 does not inject lime or limestone slurry to cause a chemical reaction with the SOX compounds.

The formulas for the scrubber—gas cooling and dissolution are as follows:

NO₂+H₂O>H+NO₃

SO₃+H₂O>H₂SO₄

FIG. 7 is a graph illustrating the effect on NOX emissions in the reaction chamber 12 and the scrubber 16 without injecting ozone, but simply using spray water. As indicated by the data, the actual NOX emissions from the test unit increased, whether 0.5 GPM or 1.22 GPM were sprayed in the scrubber 16. Similar results have been observed at commercial power plant installations, where air leakage into the combustion gas stream has caused some of the unreacted nitrogen in the gases to react with available excess oxygen to form NOX constituents.

This data clearly demonstrates that NOX reduction by simply scrubbing the gases with water will not occur. In commercial wet scrubber installations, water is injected containing calcium carbonate, and/or other chemicals, which reacts with the SOX constituents to reduce the SOX in the gas stream, but has no effect on the NOX. FIG. 7 demonstrates that water spray alone has no effect on the reduction of NOX, as the primary component, NO, is highly insoluble in water, as previously explained.

FIG. 8 demonstrates that after pretreatment by a minute quantity of ozone in the reaction chamber, NOX is significantly reduced by increasing amounts of water spray quantities. This occurs because the NO component has been converted to NO₂, and thus has become significantly more soluble in water. In contrast to FIG. 7, additional spray seems to increase the amount of NOX that goes into solution, and therefore is not exhausted out of the stack. Note also that contact time is relevant to the amount of NOX reduction. It appears that after reduction, the particles begin to dissociate. Therefore, the present invention provides the ability to vary the contact time by varying the position of the injection ports 26-32.

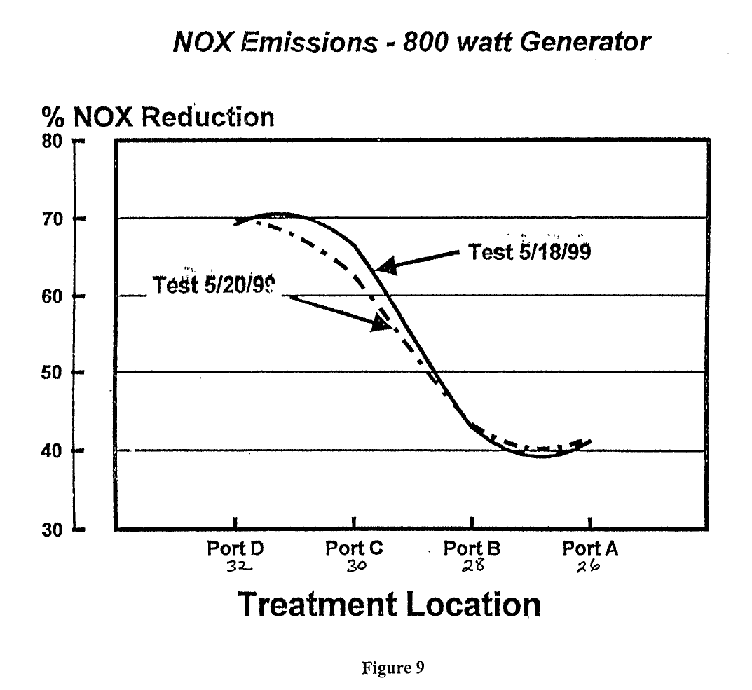

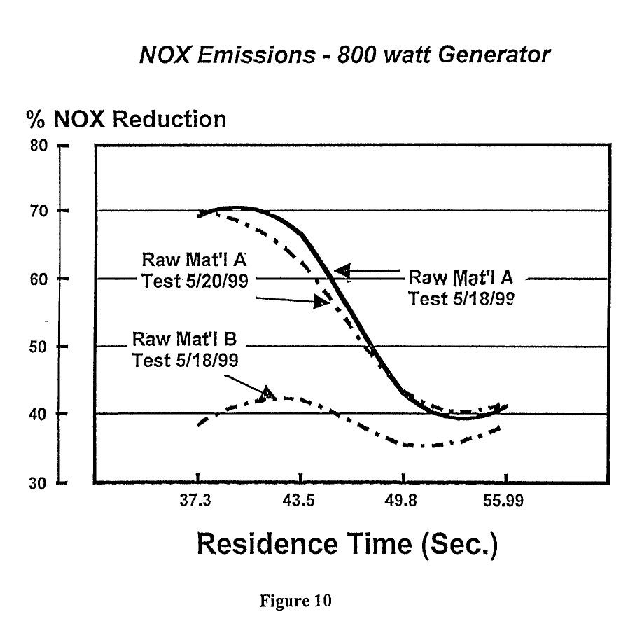

FIG. 9 presents data showing the percentage of NOX reduction depending on the port from which ozone is injected into the reaction chamber 12 (Treatment Location). When viewed in combination with FIGS. 3 and 10, it is seen that exhaust gas in the lab-scale system having a contact time with ozone of approximately 37 seconds (gas entering from port 32 ) results in the highest NOX reduction.

FIG. 10 further illustrates both that 1.) air (Material A), as the raw material used as the input to an ozone generator has significantly greater effect on reducing NOX emissions than oxygen (Material B). Additionally, 2.) air as the raw material input, has a dramatic effect on the NOX reduction as the overall residence time is reduced, and an optimum value established.

Once the effluent gases enter the reheater 18 or the stack 20, analyzers are then employed to measure the remaining NOX, SOX, and other pollutants. For purposes of testing, the minimum gas sampling points should be located at the inlet and outlet of each component. Added value is obtained by also sampling the NOX, SOX, and other key combustion constituents at intermediate points. From the viewpoint of compliance with EPA and other governmental regulations, the sampling locations, methods, and testing procedures are defined by those environmental laws and regulations. The government standards for each pollutant can be found in CFR Title 40: Protection of Environment/Chapter 1/Sub-chapter C, with numerous references to relevant Subparts. Particular reference is made to the Table of Contents for both Sub-Chapter C, 62-297.401 “Compliance Test Methods” and Part 60 (Updated 1999)—“Standards of Performance for New Stationary Sources.” The specific language for these standards may be found at the internet address—www.epa.gov/epacfr40/chapt-Linfo/subch-C /40P0060/40P060D.pdf and at www.epa.gov/epacfr40/chapt-Linfo/subch-C /40P0060/40PO60Da.pdf.

Wastewater Treatment

After removing the pollutants in the combustion gases, including NOX, SOX, VOC, CO₂, and Heavy Metals, by placing these constituents into an aqueous solution, the aqueous solution must be cleaned in order for the water to be recycled to the scrubber 16. A fractional portion of this wastewater stream may be discharged according to applicable EPA regulations.

The primary constituents that must be removed are HNO₃ and H₂SO₄ These pollutants are removed by wastewater treatment systems, such as the processes described in the CBR patents.

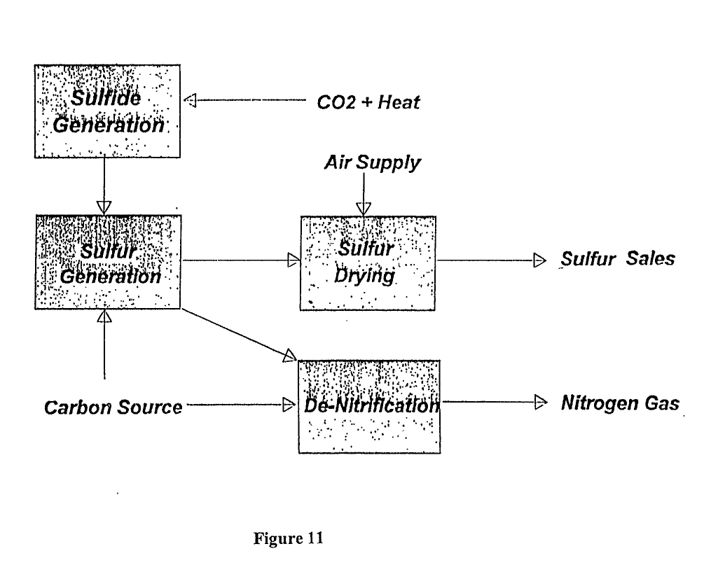

As illustrated in FIG. 11, there are three (3) separate water treatment stages used:

De-nitrification

Sulfide Generation

Sulfur Generation and Recovery

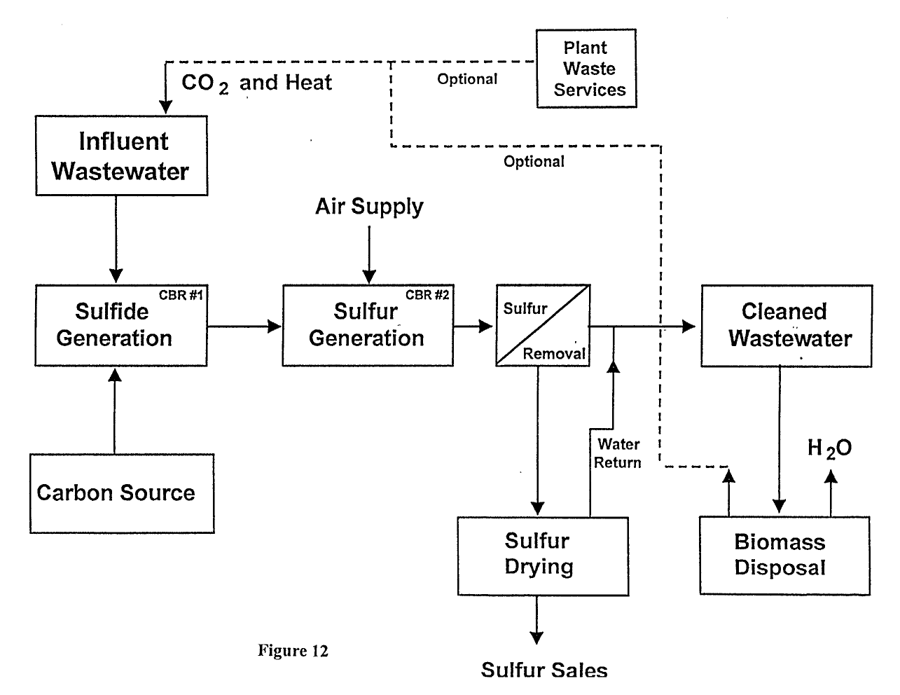

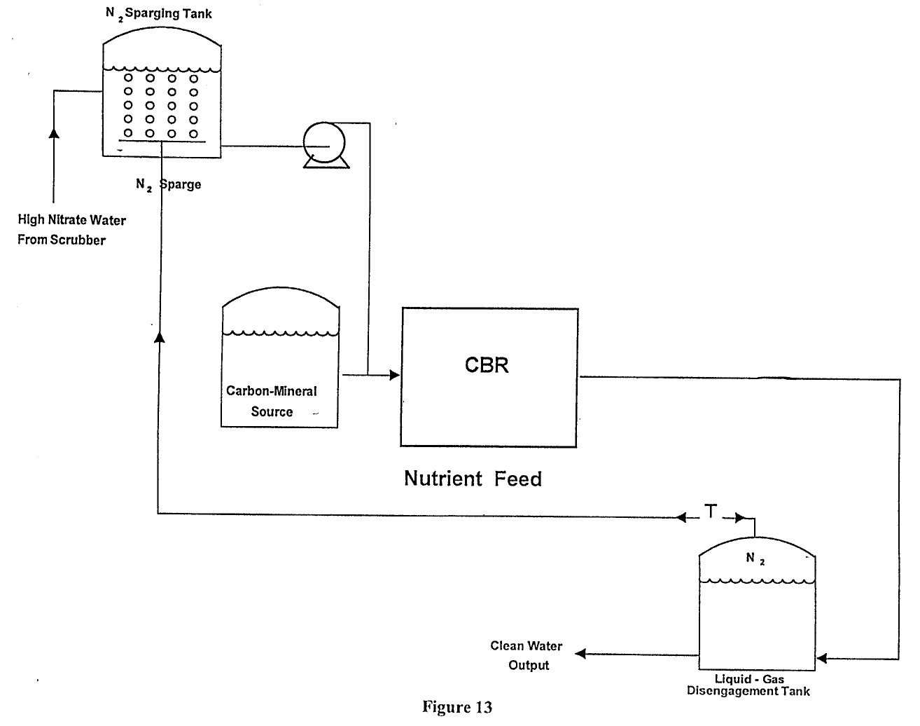

FIGS. 12 and 13 illustrate the overall process employed to clean the aqueous liquid exiting the sump of the scrubber of sulfuric acid (H₂SO₄), and nitric acid (HNO₃). As outlined in FIG. 12, the wastewater contains a dilute H₂SO₄ (sulfuric acid) solution, which is subsequently removed by: (1) sulfide generation; and (2) sulfur generation. Note that this sequential methodology disclosed in the CBR patents is radically different from conventional methodology.

Sulfide Generation

A considerable body of scientific research (Refs. 1-5) has demonstrated that sulfate-reducing bacteria (SRB) supplemented with a quantity of organic waste products [generically Cₓ(H₂O)ₓ] will avidly convert sulfate ion in acidic solution to sulfide:

C₂(H₂O)₂+SO₄⁻²+H⁺→2CO₂+2H₂O+HS⁻ (1)

This process (in a non-optimal form) is utilized by a number of companies currently engaged in waste sulfate removal (for example, Thiopaq Sulfur Systems BV, AB Balk, Netherlands, and Biothane Systems Int'l., Camden, N.J.). There are several characteristics of the SRB-mediated process. First of all, it is an anaerobic process—one that requires that the oxygen content of the sulfate-containing wastewater be drastically reduced before the process will function. It is typically very slow, requiring retention times in excess of 50 hrs. There is also a requirement for an organic electron donor, which is both difficult (SRB are selective as to which organic material they will metabolize) and expensive. Finally, the process operates optimally at a defined temperature and at low pH—any attempt to raise the pH for some secondary purpose (as is the case for both Thiopaq and Biothane) results in process slowdown.

The CBR patents provide processes that optimize the SRB-mediated conversion of sulfate ion to sulfide ion (Eqn. 1, above). The completion time of the SRB-mediated process is decreased by increasing the quantity of SRB's per unit volume by a factor of at least 10³. As an example, consider the processing of 50,000 gal of sulfate-containing wastewater. Using conventional technology, this volume is placed in a reactor “tank”, the appropriate quantity of SRB's and organic co-substrate is added, and the mixture stirred for the “retention time” necessary to convert the added sulfate into sulfide. Finally, the sulfide-containing water must be “decanted” or otherwise separated from the SRB population and the overall process repeated. This conventional process is both capital and labor intensive.

Using the CBR patented processes, on the other hand, the same SRB population is immobilized in no more than a 50 gallon CBR unit and the 50,000 gallons of wastewater is pumped through the unit in the same time period as was required for the conventional process. Furthermore, if it were advantageous that the system “retention time” be decreased from 50 hrs to 10 hrs, the CBR capacity for SRB's could simply be increased from 50 gal to 250 gal—a size increase which is unremarkable for CBR machinery—but is one that would allow an 80% decrease in retention time. This would be impossible to accomplish by any means using conventional technology.

Organic co-substrate costs are minimized by utilizing waste materials, such as sewage, or milk whey as the organic supplement.

Finally, the need to operate a maximally efficient SRB-mediated sulfate reduction unit anaerobically, at a constant low pH, and at an optimal temperature is more easily accomplished with the immobilization of the SRB population in CBR units. Anoxic conditions are achieved by allowing aerobic microbiological growth to occur in the SRB cell volume adjacent to the wastewater input. This accomplishes two things: first, the influent wastewater is scrubbed of its oxygen content, allowing the remaining 95% of the SRB array to perform sulfate reduction; and secondly, the aging SRB population in the CBR unit is constantly replenished by the oxygen-supported growth at the “front end.” The problem of temperature optimization for large volume wastewater treatment has traditionally been ignored. Virtually all conventional processes operate at ambient wastewater temperature simply because the costs of heating are prohibitive. The process efficiency thus varies with the temperature of the input wastewater. By utilizing water from the scrubber, ambient water temperatures in an optimum temperature range from 80 to 100° F. (26.7 to 37.8° C.) are obtained, simply from the heat generated by the combustion gas stream.

Similarly, pH optimization is largely ignored except in the cases where selective precipitation of metal sulfides is desired. In these latter cases, the pH is actually perturbed farther away from a SRB optimum in order to facilitate metal capture. As will be seen in a subsequent section, the processes of the CBR patents separate sulfate reduction from metals capture and thus are able to optimize both processes. Temperature and pH maintenance are achieved in the processes of the CBR patents by the utilization of waste heat and carbon dioxide produced downstream of the sulfide generation unit and will be more fully discussed in a subsequent section.

Sulfur Generation and Recovery

The sulfide generated in the preceding process step can be converted into elemental sulfur by the action of a mixed population of microorganisms (Refs. 6-7). The chemistry of the process is:

HS⁻+O₂→S⁰₍ₛ₎+OH⁻ (2)

There are three characteristics of this process. First, the reaction is very facile and is common to many sulfate- and sulfur-reducing bacteria (notably Desulfovibrio desulfuricans) under oxidative conditions. Next, the reaction rate is directly dependent on the availability of molecular oxygen. That is, the more oxygen that is made available, the more elemental sulfur will be produced. Finally, the reaction is most optimal at acidic pH but generates hydroxyl ion (OH⁻) that results in a pH climb that gradually slows and then stops the reaction in conventional stirred tank reactors.

Again, the processes and apparatuses of the CBR patents are ideally suited for the optimization of this process. First, a second CBR unit is loaded with the appropriate microorganism(s) specific for sulfide oxidation. Next, the acidic sulfide-containing effluent of the first CBR unit is connected to the input of the sulfur-generating CBR (see FIG. 12). Finally, the hydraulic pressure of this segment of the system is raised to approximately 150 psig. This last step is performed so that oxygen (from air) may be directly dissolved into the acidic sulfide-containing input liquid prior to the presentation of this liquid to the immobilized sulfur-generating microorganisms. The chemistry of Eqn. 2 above then occurs with the production of elemental sulfur particles and base (OH⁻).

There are several advantages of this CBR-mediated process over conventional stirred tank technology. For example, it allows the scale of the process machinery to be reduced by a factor of about 111000. Just as was the case for a 50,000 gal sulfide generator (reduction to a 50 gal CBR), the same volume reduction is typically obtained in this sulfur-generating step. Next, the costly problem of a gradual pH rise as a result of OH⁻ production in conventional stirred tank technology is completely eliminated in the CBR system. All of the OH⁻ produced by the sulfur-generating microorganisms is carried away by the continuation of the process flow. In other words, there is a sharp pH change across this CBR unit. The pH of the input (typically pH=3.5) abruptly changes to a pH near 7.0 at the output of the unit with the pH at the center of the immobilized array of the sulfur-generating microorganisms invariant and near 5.5, the optimal pH for their activity.

Note, the ability to operate this CBR unit at increased hydraulic pressure allows exactly the appropriate quantity of oxygen to be delivered to the sulfur-generating microorganisms at low cost.

The delivery of oxygen to bioreactors has been a major problem in conventional systems. The sparging of air (or oxygen) into a stirred tank is generally very inefficient with mass transfer from the gas phase to the liquid phase hardly able to maintain dissolved oxygen at 80% of air saturation. Further, gas sparging of a frothy, HS^{—} and S⁰-containing solution greatly hinders subsequent sulfur recovery and results in a gas disposal problem.

In the processes of the CBR patents, air and/or oxygen is dissolved directly into the influent liquid at increased hydraulic pressure allowing oxygen concentrations to be increased and maintained at any desired concentration without any sparging or any gas discharge. Finally, the sulfur generating processes require no additional nutritive input to maintain the sulfide-oxidizing microorganism population. The inevitable leakage of organic material from the upstream sulfide generation unit as a result of incomplete carbon utilization (typically acetate and proprionate) provides sufficient organic supplementation to maintain the oxidative sulfur-generating microorganisms at an optimal population size.

The elemental sulfur so produced is carried out of the sulfur-generating CBR unit as a micro-particulate solid. It can be, for instance, collected in a conventional tilted plate separator and de-watered in a conventional decanting centrifuge. There is an immediate market for elemental sulfur in the chemical industry.

In another embodiment of the invention, vaporized metals in gases, including mercury emissions from smoke stacks, may be removed. Generally, the metals precipitate as ash, and are absorbed on the walls of the combustor, finally ending up in an ash pond or as solid waste. The remainder exits through the smokestack, as dioxins, furans, and VOC's. For example, the mercury content from smokestacks is approximately 3,000 pounds per year.

The present invention takes advantage of the fact that all metals, including but not limited to aluminum, iron, copper, zinc, and lead, at these temperatures will vaporize, or exist in a gaseous phase. The apparatuses and methods of the present invention will remove these metals in their vapor state, by first precipitating them, and then capturing by absorption into the membrane wall of the microbes used in the CBR.

Methods for Recycling Water through the CBR Process

When the emissions from a 273 MW power plant are to be scrubbed, the wastewater utilized by the invention is approximately 650,000 pounds of water per hour. Each CBR module within the system has the ability to process approximately 64,000 pounds of water per hour. ten to twelve modules would therefore be needed to provide the treatment capacity for each type of pollutant. A separate anaerobic biofilm is required for removing NOX, while an aerobic biofilm is needed for removing SOX.

These and other benefits are more fully described in the CBR patents.

FIG. 13 provides an outline of the process used to remove the dilute nitric acid from solution. More detail disclosing the nitrate removal process is found in the CBR patents.

The immobilization and culture process disclosed in the CBR patents has its origin in four distinct areas of knowledge. The function of the overall process depends on the use of information from all four areas for its proper function. These areas are: (1) Stoke's Law and the theory of counterflow centrifugation; (2) the geometrical relationships of flow velocity and centrifugal field strength; (3) Henry's Law of Gases; and, (4) the effect of hydraulic pressure on single and multicellular organisms and their cellular or subcellular components.

Substantial immobilization of three-dimensional arrays of particles (cells, subcellular structures, or aggregated biocatalysts) is achieved and the particles are provided with a liquid environment containing dissolved gases which will maximize their viability and productivity. Such cells (or particles) may include, but are not limited to, a prokaryotic cell, a bacterium, or a eukaryotic cell, such as algae cells, plant cells, yeast cells, fungal cells, insect cells, reptile cells and mammalian cells. The biocatalyst may be, but is not limited to, a subcellular component, an enzyme complex, and/or an enzyme complex immobilized on a solid support.

This process utilizes a modified form of “Counterflow Centrifugation” to immobilize particle arrays. A proper application of Stoke's Law in combination with provision for the effect of gravity which also acts on the immobilized particles results in a mathematical relationship which allows for the relative immobilization of high-density arrays of such particles. The effect of gravity can be eliminated by an alternative choice of rotational axis. If rotation about the horizontal axis (y) is chosen instead of rotation about the vertical axis (z), as is most common in biological centrifugations, then the effect of gravity on immobilized particles will always be limited to action solely in the x-z plane. Since this is the same plane in which both the centrifugal as well as the liquid flow related forces are constrained to act, the motion of a restrained particle at any point in a rotational cycle is the resultant of the sum of the three types of forces acting upon it.

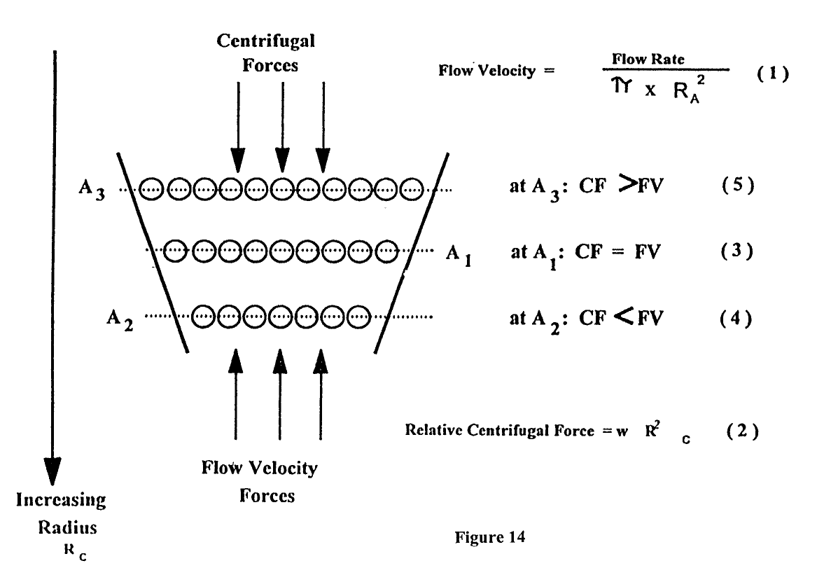

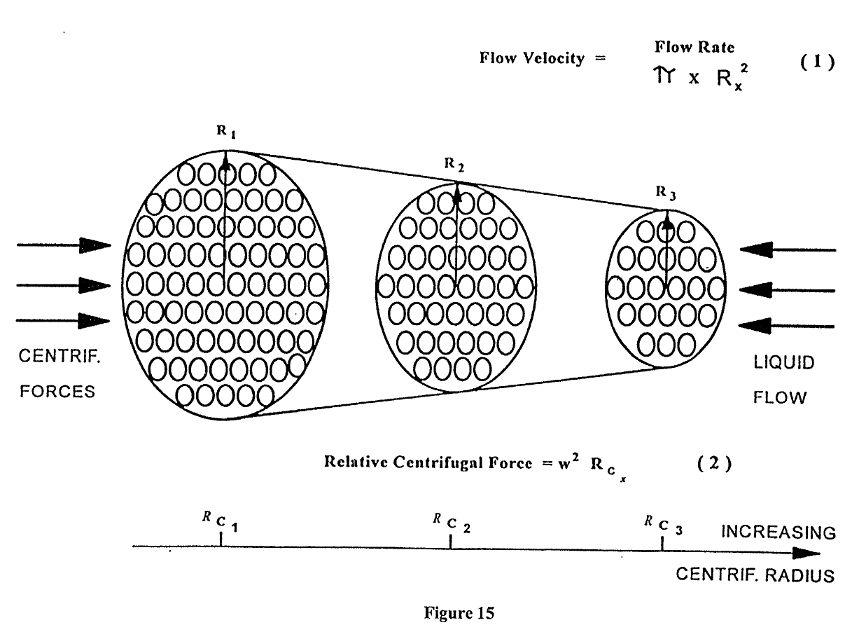

A biocatalyst immobilization chamber, as used herein, may have a geometry such that its cross-sectional area increases as the rotational radius decreases, as is graphically displayed in FIG. 14. Although the geometry of the biocatalyst immobilization chamber as depicted in FIG. 14 is that of a truncated cone, note that other geometries could be alternatively used—subject to the constraint that the cross-sectional area of the chamber increases as the rotational radius decreases. Thus, as is depicted in FIG. 15, it is possible to constructa three-dimensional array of particles in a varying centrifugal field opposed by a liquid flow field if the biocatalyst immobilization chamber geometry chosen allows for a flow velocity decrease greater than or equal to the centrifugal field strength decrease as the rotational radius decreases. In the geometry chosen in FIG. 15, that of a truncated cone, the two-dimensional arrays of particles at each rotational radius (R_{c}) will each be constrained to motion toward that radius where the opposing forces are exactly equal.

In actual use, it has been determined that, for the case of a chamber geometry of a truncated cone, it is preferable that the most distal region of the truncated cone be the region where an exact equality of centrifugal forces and liquid flow velocity is achieved.

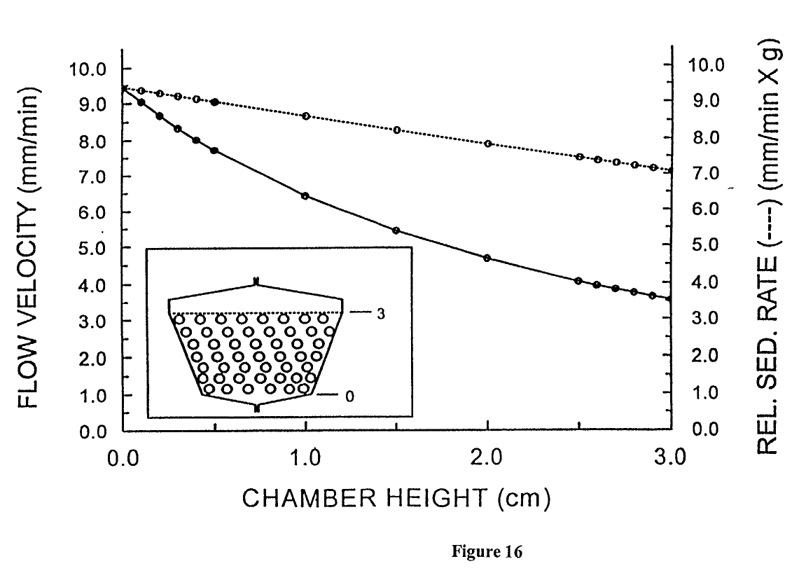

FIG. 16 is a profile of the relative magnitudes of the flow-related forces and the centrifugal forces across a biocatalyst immobilization chamber of conical cross-section which has dimensions in this example of: large diameter=6.0 cm, small diameter=3.67 cm, and depth=3.0 cm. The Relative Sedimentation Rate is defined as the product of the intrinsic sedimentation rate of a particle due to gravity in a nutrient media at its optimal temperature and the applied centrifugal field. For a given flow rate (in this example 10 mL/min) into a biocatalyst immobilization chamber of the indicated dimensions, where the proximal end of the biocatalyst immobilization chamber is 9.0 cm from the rotational axis, the product of the intrinsic particle sedimentation rate due to gravity and the angular velocity is a constant at the given flow rate in order to satisfy the desired boundary conditions. In other words, the angular velocity need not be specified here since its value depends only on the particular particle type to be immobilized. The dotted line in FIG. 16 displays the linear variation in the centrifugal field strength from the bottom to the top of the biocatalyst immobilization chamber, while the solid line displays the corresponding value of the flow velocity. At the bottom of the chamber (the most distal portion of the chamber), the forces are equal and a particle at this position would experience no net force. At the top of the chamber, a particle would experience a flow-related force which is only one-half of the magnitude of the centrifugal field and would thus be unlikely to exit the chamber, even in the presence of a nearby region of decreasing cross-sectional area (the chamber liquid exit port), where flow velocities will increase markedly.

It should be clear from the foregoing that, subject to the necessary condition that the cross-sectional area increases as rotational radius decreases, there are other geometrical chamber configurations whose shape could be manipulated in order to establish boundary and intermediate relationships between the applied centrifugal field and the liquid flow velocity forces at any radial distance in order to establish desired resultant force relationships in the three-dimensional particle arrays. In practice, however, it is undesirable to utilize geometries with rectangular cross-sections as a result of the anomalous effects of coriolis forces which act in a plane transverse to the rotational plane. In the case of rectangular cross-sections, these otherwise unimportant forces can contribute to interlayer particle motion.

It should also be clear from the foregoing that the effect of gravitational forces acting on the individual particle masses which acts independently of the applied centrifugal forces are even less important than was indicated earlier. In particular, since the basic effect of gravity on an otherwise immobilized particle is to either cause radial lengthening or radial shortening, such a motion of a particle will necessarily bring it either into a region of increased flow velocity magnitude (longer radii) or decreased flow velocity magnitude (shorter radii) with only a much smaller change in centrifugal field strength (see FIG. 16).

As a consequence, the periodic motion of a particle due to gravitational effects on its intrinsic mass will be severely dampened in the presence of such unbalanced opposing force fields and will amount to, in the case of low mass particles such as biocatalysts, a “vibration in place.” It should also be obvious from the foregoing that there could be, in a practical sense, a severe problem with the maintenance of the immobilized particle arrays in the above fashion when these particles are aerobic cells, micro-organisms, or biocatalytic substructures. Such structures require, in addition to liquid nutrients, the provision of certain nutrients which are gases at ambient temperatures and pressures. For example, the large majority of cells or micro-organisms which are valuable in the production of commercial biochemicals are aerobes. That is, they require oxygen for viability. While these living organisms (or their subcellular constituents) can only utilize oxygen in a dissolved form, the only method of providing oxygen heretofore was by bubbling or sparging oxygen through the nutrient liquid in which the cells are suspended in order to effect the solubilization of oxygen. Further, most living organisms (including certain anaerobes) produce metabolic wastes which are gases (for example, carbon dioxide or methane). If gas volumes were either introduced into or generated from metabolic processes occurring in the immobilized three-dimensional arrays of particles discussed above, then the careful balance of forces which provides for their immobilization would be destroyed.

Applying Henry's Law, in essence, the quantity of a gas which may be dissolved in a liquid is a function of the system pressure. Thus, if the hydraulic pressure of the liquid-containing system (the biocatalyst immobilization chamber and the liquid lines leading to and from the biocatalyst immobilization chamber) are maintained at a hydraulic pressure sufficient to fully dissolve the necessary quantity of input gas and to insure the solubility of any produced gases, then there will be no disturbance of the immobilization dynamics.

As used herein, the terms “biocatalyst immobilization chamber”, “reactor chamber”, “bioreactor chamber”, “cell confinement chamber”, “centrifugal confinement chamber”, “centrifugal cell chamber”, “immobilization chamber”, “chamber”, “compartment”, or “confinement chamber” are all equivalent descriptive terms for the portion of the invention described herein where cells or biocatalysts are suspended by the described forces. Use of these equivalent terms does not imply an estoppel or limitation of the description of the invention.

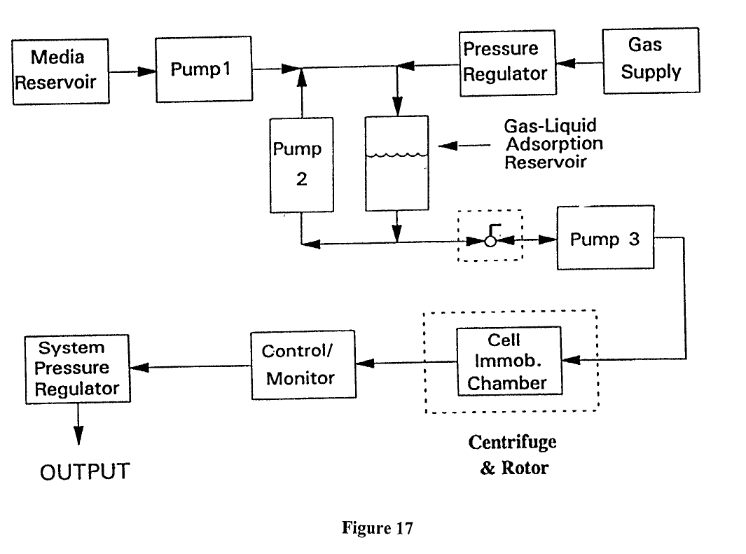

FIG. 17 is a block diagram which demonstrates one method by which the maintenance of such a gas-free, completely liquid system at hydraulic pressures greater than ambient may be effected. In this system, the indicated pumps are all positive displacement pumps. That is, liquid is constrained to motion through the pumps in the directions indicated by the arrows. Pump 3 is the primary feed pump which moves liquids into and out of the cell immobilization chamber which is located in a centrifuge rotor. The raising of the hydraulic pressure in the circuit containing Pump 3 and the cell immobilization chamber is accomplished by placing a liquid pressure regulator, the system pressure regulator, at a position in the circuit downstream of the cell immobilization chamber. Thus, the setting of a pressure limit higher than ambient on the system pressure regulator results in no liquid flow through this circuit until the positive displacement pump, Pump 3, moves enough liquid into the circuit to raise the system hydraulic pressure to a value near this setting. Once an equilibrium system pressure is established, the pressurized liquid downstream of Pump 3 will flow continuously at a rate set by control of Pump 3.

In order to dissolve an appropriate amount of a desired nutrient gas into the liquid input to Pump 3, a Gas-Liquid Adsorption Reservoir is placed in the input line leading to Pump 3. Non-gassed liquids are moved from the Media Reservoir into the Gas-Liquid Adsorption Reservoir by means of Pump 1. Quantities of the desired gas (air or oxygen, for example) are, at the same time, let into the Gas-Liquid Adsorption Reservoir through a pressure regulator set for the gas pressure required to insure the solubilization of the desired concentration of the gas into the nutrient liquid. Note that, in the steady-state, it is necessary that Pump 1 be operated at the same flow rate set for Pump 3. Pump 2 is a recirculation pump which is operated at a flow rate higher than that of Pumps 1 and 3. Pump 2 is used to increase the contact between the gas and liquid phases of the Gas-Liquid Adsorption Reservoir so that a desired concentration of gas dissolved in the nutrient liquid is maintained in the bulk of the volume of liquid in the Gas-Liquid Adsorption Reservoir. It is essential, because of the nature of positive displacement pumps, that the magnitude of the system pressure set with the System Pressure Regulator be higher than the pressure magnitude set in the Gas-Liquid Adsorption Reservoir. In order to make available, at any time, a sufficient volume of liquid equilibrated with the desired concentration of gas(es), a valve on the input to Pump 3 may be utilized to allow such equilibration to occur prior to any actual use. Similarly, by means of switching valves, the liquid input to Pump 3 may be changed from that indicated in FIG. 17 to any other input reservoir desired, subject to the constraint that the hydraulic pressure of such a reservoir be lower than the value of hydraulic pressure set by the System Pressure Regulator.

It should be obvious that the block diagram of FIG. 17 is a representation of one of many process flow configurations which may be employed in order to flow a gas-free pressurized liquid through a centrifugal bioreactor chamber. In particular, one may envision many different methods of insuring adequate mixing of gas and liquid in order to effect the solubilization of a measured quantity of gas into the liquid. What is central to the process of this invention is: (1) that the liquid circuit comprising the bioreactor chamber and the liquid transport lines (into and out of the bioreactor chamber) be operated at a hydraulic pressure greater than ambient pressure; (2) that there be provision for the solubilization of a desired quantity of a gas into the liquid prior to its insertion into the liquid circuit leading to the bioreactor chamber(s); and (3) that the system hydraulic pressure be maintained at a high enough value to keep both the input gas(es), as well as the respiratory gas(es) which may be produced by biological systems in solution throughout the liquid circuit, upstream of the system pressure regulator and downstream of Pump 3. Hydraulic pressures of 100-2000 psig have proved sufficient to maintain a gas-free liquid environment for all possible conditions of cell density and cell number.

There will be no measurable deleterious effects on the culture of animal cells or micro-organisms or their subcellular constituents as a result of the necessity to increase the hydraulic pressure of their environment in the biocatalyst immobilization chamber at hydraulic pressures below 10,000 psig. The successful culture of living cells using bioreactor headspace pressurization is a proven and established culture method, albeit limited in scope to pressures of less than 50 psig (see Yang, J. and Wang, N. S. (1992) Biotechnol. Prog. 8, 244-251 and references therein). At hydraulic pressures of 15,000 to 30,000 psig some disassociation of noncovalent protein complexes has been observed, although pressures of more than 90,000 psig are required to denature monomeric proteins (Yarmush, et al. (1992) Biotechnol. Prog. 8, 168-178). It is a seldom appreciated, but well known fact that living cells (and their constituent parts) are unaffected by, and indeed cannot sense hydraulic pressure magnitudes below those limits outlined above. This may best be appreciated in considering the effects of hydraulic pressure on marine organisms. For every 10 meters of depth under the sea, approximately one atmosphere (14.7 psig) of overpressure is gained. Thus, for example, benthic organisms exhibiting biochemical processes and metabolic pathways identical to their shallow-water and terrestrial counterparts inhabit ecological niches and proliferate mightily at hydraulic pressures of more than 3000 pounds per square inch. Similarly, the hydraulic pressure under which terrestrial mammalian cells exist is greater than ambient, ranging from ca. 90 to 120 mm Hg greater than ambient in man, for example. The explanation for the “invisibility” of hydraulic pressure in biological systems can be understood if it is realized that hydraulic pressure in aqueous systems has, as its “force carrier,” the water molecule. Since the lipid bilayer which forms the boundary membrane of living cells is completely permeable to water molecules, an applied hydraulic pressure in aqueous systems is transmitted across the boundary membranes of cells or subcellular organelles by the movement of water molecules with the result that the interior(s) of cells rapidly equilibrate to an externally-applied aqueous hydraulic pressure.

There are situations in which hydraulic pressures are deleterious to living cells. For example, if a pressure field in an aqueous system is varied at high frequency, then it is possible to cause cell disruption by means of pressure differentials across the cell boundary membrane. However, the frequency required for such lethal effects is quite high; on the order of thousands of cycles per second. As long as the pulsatile pressure of pumping in the process of this invention is kept below such a limit there is no effect on cell viability for even the most fragile of cells as a result of pressure fluctuations. In addition, cell replication is completely unaffected by culture at increased hydraulic pressure.

The problem of the introduction and withdrawal of pressurized liquid flows into and out of a rotating system has been solved by innovations in seal design over the past twenty years. High performance mechanical end-face seals are available which are capable of operation at rotational rates in excess of 5000 revolutions per minute while maintaining a product stream hydraulic pressure of more than 2000 psig. Such seals are available from Durametallic Corporation (2104 Factory Street, Kalamazoo, Mich. 49001). Such high-performance mechanical seals have leakage rates below 5 liters per year, can be cooled by pressurized refrigerated liquids of which inadvertent leakage into the product stream at the above leakage rates will have no effect on biological systems, and can be operated in a manner which provides for the maintenance of absolute sterility in the product stream. The somewhat inexplicable aversion to the use of mechanical end-face seals for use in centrifugal bioreactor systems (see U.S. Pat. Nos. 4,939,087 and 5,151,368, for example) results in a perceived necessity for the connection of flexible tubing (and complicated mechanisms for its “untwisting”) in conventional designs. Such designs are, as a result, limited to: (1) hydraulic pressures near one atmosphere as a consequence of tube flexibility requirements; and (2) low rotational speeds and short bioreactor run times as a result of the vigorous motion of these flexing connections. The use of modem high performance mechanical end-face seals eliminate all of these drawbacks to centrifugal bioreactor performance.

Immobilization of three-dimensional arrays of particles in a force field, which is comprised of outwardly-directed centrifugal forces which are opposed by inwardly-directed liquid flow forces has been described. The effect of gravitational forces which act, inevitably, on even the smallest and lightest of particles over prolonged time periods can be essentially negated and reduced to a small periodic “vibration in place” by the proper choice of rotational axis. The disruptive effects of the possible introduction of gases into this system have been accounted for by raising the hydraulic pressure of the liquid system to values which assure that such otherwise gaseous chemicals will remain dissolved in the flowing liquid. It has been emphasized that the necessary increase in hydraulic pressure will have no effect on biological units such as cells, microorganisms, or their subcellular constituents.

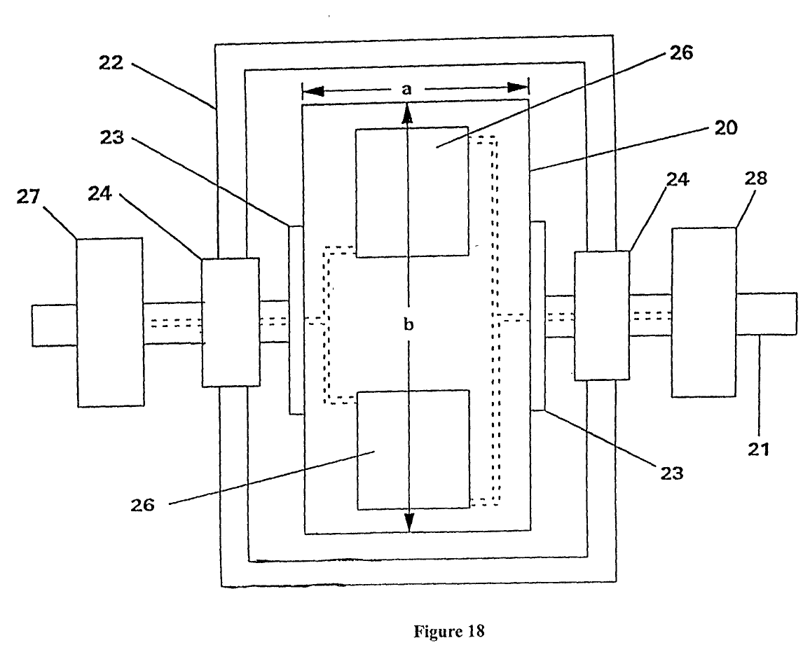

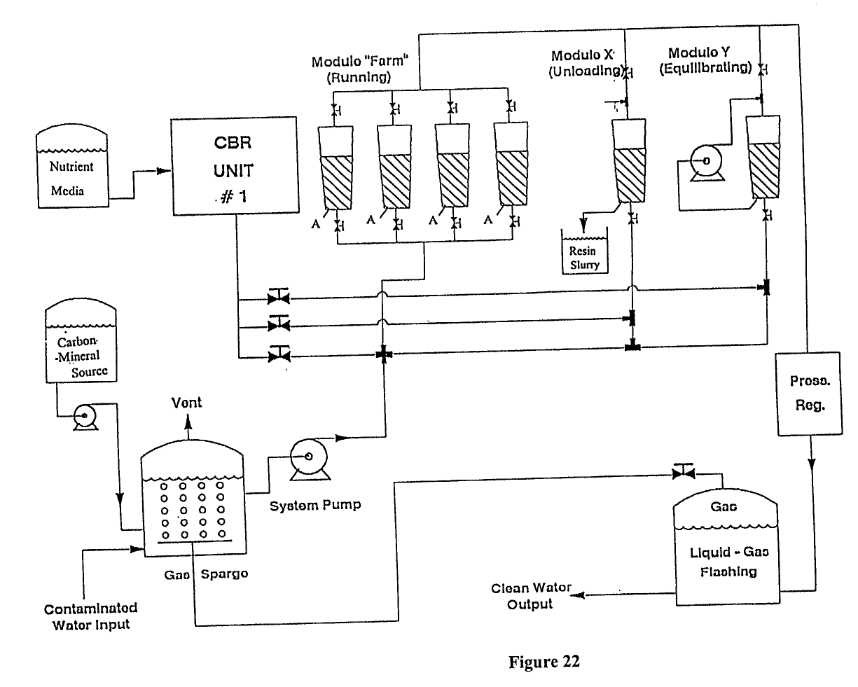

In the following paragraphs, we present and analyze a number of embodiments of the invention. FIG. 18 depicts the components of an embodiment of the present invention. A cylindrical rotor body 20 is mounted on a horizontal, motor-driven rotating shaft 21 inside a safety containment chamber 22 bounded by metal walls. The rotor body 20 is fixed in position on the rotating shaft 21 by means of locking collars 23. The rotating shaft 21 is supported on either side of the rotor body 20 by bearings 24. The rotating shaft 21 extends outside the safety containment chamber 22 for a distance and ends in a terminal bearing and end cap 29 mounted in an external housing 25. Liquid flows are introduced into and removed from bioreactor chambers 26 mounted in the rotor body 20 by means of a liquid input mechanical end-face seal 28 and a liquid output mechanical end-face seal 27 which communicate with liquid channels (50, 51 in FIG. 22) within the rotating shaft 21. Typical dimensions for an example rotor body 20 (a=36 cm and b=15 cm) are entirely reasonable and comparable to rotor dimensions known to those skilled in the art.

FIG. 18 is a view of the rotor body 20 of FIG. 18 as viewed parallel to the axis of rotation. The rotor body 20 is machined with a shaft mounting channel 30 through its center to allow its mounting on the rotating shaft (21 in FIG. 18), and is machined to have chamber-positioning recesses 32 into which cylindrical demountable bioreactor chambers (26 in FIG. 18) may be placed. The rotor body 20 is also machined to have radial rectilinear channels 33 in which liquid lines communicate with the bioreactor chambers. In actual use, a circular cover (not shown) would be attached to the surface of the rotor body 20 to close the rotor body 20.

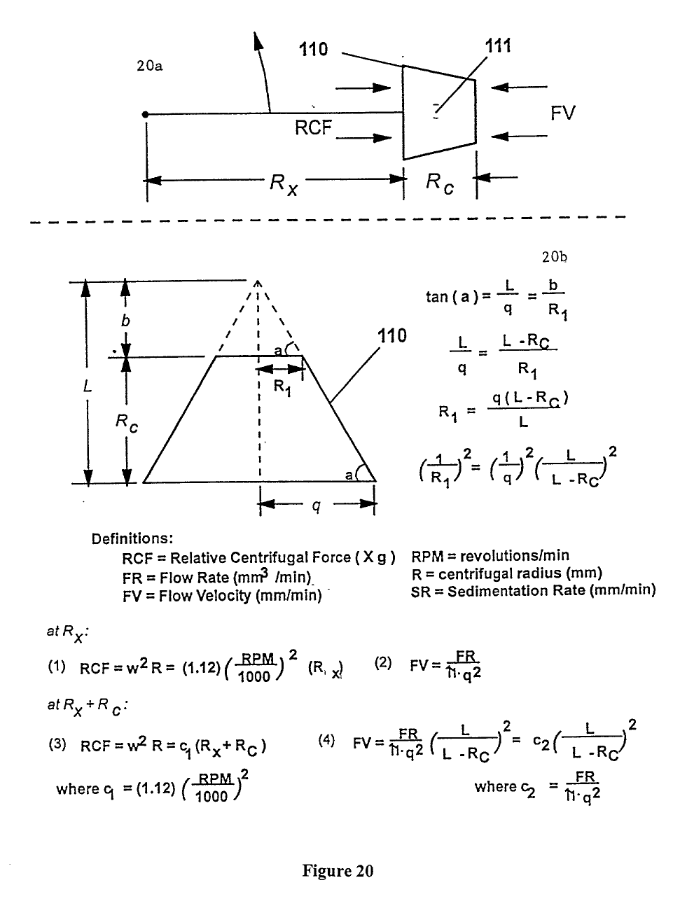

In an embodiment of this invention, described above, a portion of the geometry of the biocatalyst immobilization chamber is that of a truncated cone. As is shown in FIG. 20, the dimensional problem of determining the “aspect ratio” (the ratio of the small radius of the truncated cone 110 to the large radius of the truncated cone) of the biocatalyst immobilization chamber due to boundary condition constraints can be reduced to an examination of the geometrical relationships between the large and small radii of the truncated cone 110 and the height of the truncated cone 110.

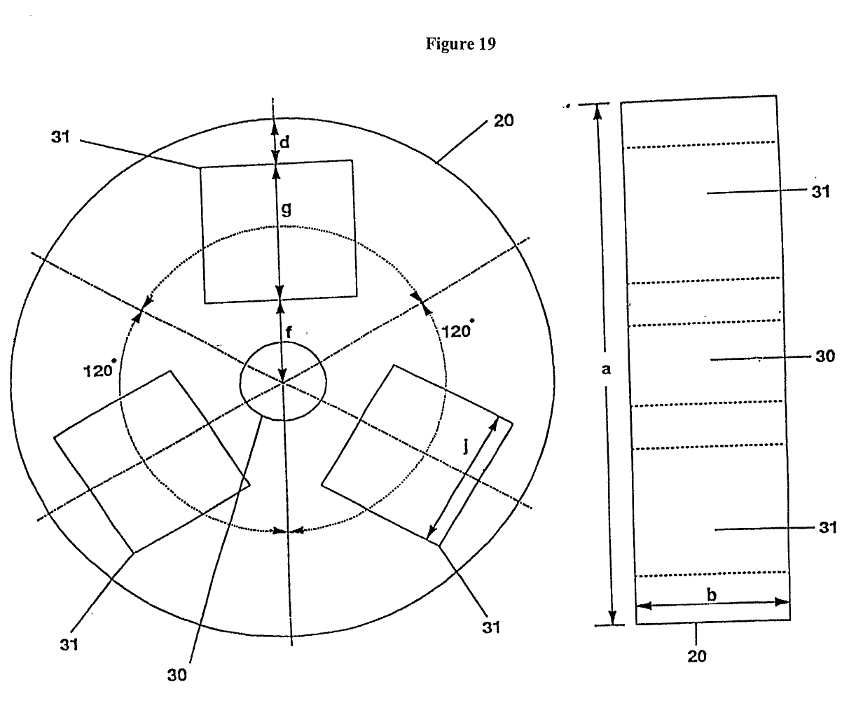

FIG. 20A is a sectional view, through the plane of rotation, of the portion of the biocatalyst immobilization chamber which resembles a truncated cone 110. The truncated cone 110 has a proximal face which is located a distance of Rₓ from the center of rotation. The truncated length of the cone is R_{c}. Relative Centrifugal Force (RCF) acts to cause translation of a particle 111 in the biocatalyst immobilization chamber to longer radii, while liquid flow forces (FV) act to cause translation to shorter radii. Equation (1) of FIG. 20B is an expression for the magnitude of the Relative Centrifugal Force (RCF) at radial length (Rₓ) in terms of the Rotor Speed (RS). Equation (2) is an expression for the magnitude of the Flow Velocity (FV) at radial length (Rₓ) in terms of the liquid Flow Rate (FR) and the large radius (q) of the truncated cone 110. Equation (3) is an expression for the magnitude of the Relative Centrifugal Force (RCF) at radial length (Rₓ+R_{c}) in terms of the Rotor Speed (RS). Equation (4) is an expression for the magnitude of the Flow Velocity (FV), at radial length (Rₓ+R_{c}), in terms of the liquid Flow Rate (FR) and the given dimensions of the truncated cone 110 and its sections. In order to determine the “aspect ratio” of the truncated cone 110 which will satisfy certain boundary conditions, given the physical dimensions of the rotor body (20 in FIG. 19), we have chosen to express the radius of the small end (RI) of the truncated cone 110 in terms of the length (L) of a non-truncated version of the truncated cone 110. This non-truncated version of the truncated cone 110 is shown in dotted lines in FIG. 20B.

The bioreactor chamber 26 in FIG. 18 is cylindrical and is composed of two pieces of thick-walled metal; a top piece 40 and a bottom piece 42. The top piece 40 contains a machined conical recess 47 and a machined passage 48 terminating in an output compression fitting 41 by which liquid may be removed from the bioreactor chamber 26 in FIG. 18. The bottom piece 42 is made of the same metal as the top piece 40, and is internally machined to form a biocatalyst immobilization chamber 43 of a desired geometric shape. The shape of the biocatalyst immobilization chamber depicted in FIG. 20 is that of a truncated cone with a short cylindrical volume at its top face and a short conical volume at its bottom face. In the case of certain animal cell cultures in which contact between the immobilized cells and the interior metal walls of the biocatalyst immobilization chamber should be avoided, it may be expedient to provide suitable conical inserts of, for example, polyethylene, in order to prevent such contact. Alternatively, the interior of the biocatalyst immobilization chamber might be coated with an appropriate lining material to provide the same effect.

The desired boundary conditions are: (1) that the product of the intrinsic Sedimentation Rate (SR) of the immobilized particle due to gravity and the applied centrifugal field (RCF) be exactly equal to the magnitude of the liquid flow forces (FV) at the most distal portion of the biocatalyst immobilization chamber; and (2) that this product be twice the magnitude of the liquid flow forces (FV) at the most proximal portion of the biocatalyst immobilization chamber. Thus:

at centrifugal radius=Rₓ+R_{c}

(SR)×(RCF)=FV

at centrifugal radius=Rₓ

(SR)×(RCF)=2×FV

Substituting into these equations the dimensional specifications for RCF and FV obtained from Eqns. (1-4) of FIG. 20, we now have two simultaneous equations which relate the liquid Flow Rate (FR), the Rotor Speed (RS), and the dimensions of the biocatalyst immobilization chamber:

$$( SR ) {C}_{1} ( {R}_{X} + {R}_{C} ) = {{C}_{2} ( \frac{L}{L - {R}_{C}} )}^{2} \qquad ( 1 )$$

(2) (SR) C₁(Rₓ)=2×C₂

In order to arrive at a solution to these equations, we will make the following substitutions which are based on the physical dimensional limits of the example rotor system:

Rₓ=90 mm

R_{c}=30 mm

q=30 mm

The simultaneous equations now become:

$$( SR ) {C}_{1} ( 120 ) = {{C}_{2} ( \frac{L}{L - 30} )}^{2} \qquad ( 1 )$$

(2) (SR)C₁(Rₓ)=2×^{C}₂

Substituting Eqn. (2) into Eqn. (1) yields:

$${( \frac{L}{L - 30} )}^{2} = 240 / 90$$

Solution of this quadratic expression yields

L=77.4 mm and:

$${( \frac{L}{L - 30} )}^{2} = 2.67$$

Since it was earlier determined (see FIG. 20) that:

$${R}_{1} = \frac{q ( L - {R}_{c} )}{L}$$

Thus, the smaller radius of the truncated cone which satisfies the boundary conditions is:

R₁=18.4

Now, the two simultaneous equations become:

(1) (SR)C₁(120)=C₂(2.67)

(2) (SR)C₁(90)=C₂ (2)

and, by subtracting (2) from (1) and collecting terms, we arrive at:

(3) (SR)(30)C₁=(0.67)C₂

Substitution into (3) of the values of C₁ and C₂ yields:

$$( SR ) ( 30 ) ( 1.12 ) {( \frac{RPM}{1000} )}^{2} = ( 0.67 ) ( \frac{FR}{π \cdot {q}^{2}} ) \qquad ( 3 )$$

Now we have an expression which satisfies the desired boundary conditions and physical dimensional constraints in terms of the controllable variables, RS and FR:

\sqrt{SR}(RPM)=(2.65)\sqrt{FR}

Thus, once the physical dimensions of the rotor system as well as those of the biocatalyst immobilization chamber have been determined, the range of Rotor Speeds (RS) and the system liquid Flow Rates (FR) which will constrain the particles to immobility in the bioreactor will follow a simple relationship which is dependent only on the intrinsic Sedimentation Rate (SR) of the object particle due to gravity. Note that, under the above conditions, the maximal volume of immobilization is ca. 56 mL per bioreactor chamber.

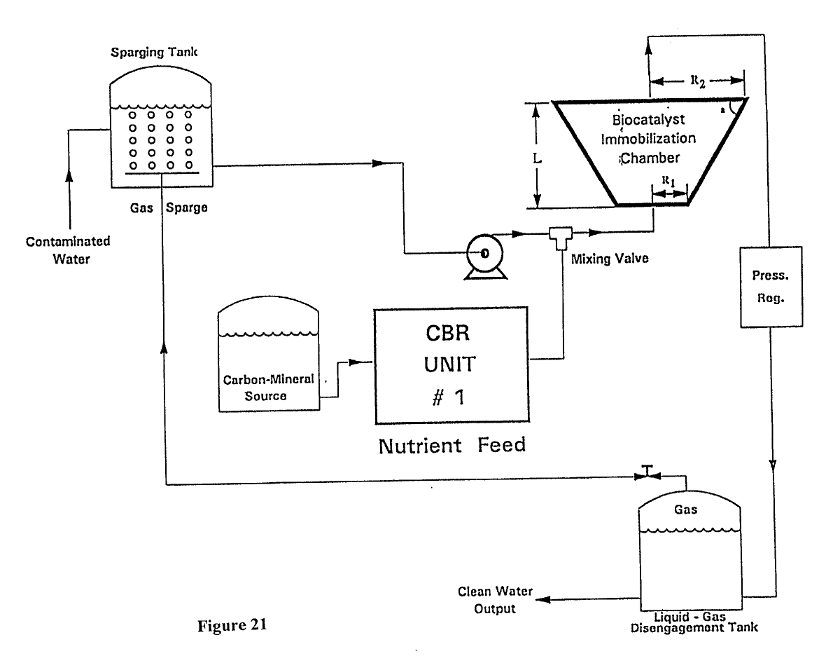

Another arrangement of the present invention is shown in FIG. 21. The present invention comprises use of several embodiments, or individual CBRs used in serial configurations. The system configuration of FIG. 21 employs one CBR embodiment (shown in the figure as “CBR UNIT #1”) to generate ethanol by, for example, anaerobic fermentation of glucose to ethanol by an immobilized fermentative yeast population. The ethanol so produced is then pumped into the downstream Biocatalyst Immobilization Chamber where, as in Example IV above, it serves as a co-substrate for the dissimulatory reduction of nitrate ion. Note further that there can be a wide disparity in the throughput and capacity of each of the serially-connected CBR units. It was shown in Example IV that dissimulation of 400 ppm nitrate required the co-presence of only 0.5 ppm ethanol. In cases such as this, CBR Unit #1 is configured to immobilize a biomass that would be one thousandth of that immobilized in the second unit and would flow at a correspondingly smaller flow rate.

Another arrangement of the present invention is shown in FIG. 22. The system configuration of FIG. 22 employs one CBR embodiment (shown in the figure as “CBR UNIT #1”) to generate replacement microbial cells for periodic introduction into a parallel array of biocatalyst immobilization chambers (“Modules” in FIG. 22). The configuration of FIG. 22 contains an array of parallel biocatalyst chambers, also called a “Module Farm”, which is identical to the configuration of FIG. 21, except that the System Pump is, in this example, supplying contaminated water to four running biocatalyst immobilization chambers (Modules in FIG. 22) while two additional off-line modules are being prepared for service.

This method and apparatus for containing a biocatalyst comprises the step of containing the biocatalyst in a bioreactor chamber placed in a centrifugal force field where the centrifugal force field is oriented in a plane parallel to the plane in which the force of gravity acts. The centrifugal force field is diametrically opposed by a continuously flowing liquid at hydraulic pressures greater than the ambient barometric pressure.

This method and apparatus for containing a biocatalyst comprises the step of containing the biocatalyst in a bioreactor chamber placed in a centrifugal force field where the centrifugal force field is oriented in a plane parallel to the plane in which the force of gravity acts. The centrifugal force field is diametrically opposed by a continuously flowing liquid at hydraulic pressures greater than the ambient barometric pressure.

In another embodiment of this invention, the immobilized biocatalyst is in a complex consisting of a dense inert support particle to which the actual biocatalyst is attached. In such an application, the buoyant force acting on the biocatalyst/support complex as a result of nutrient liquid flow can be negated, and thus immobilizing the biocatalyst/support complex, by the vertical alignment of the biocatalyst immobilization chamber so that the earth's gravitational field acts on the biocatalyst/support complex to provide the required counter-acting force. Further, the range of flow rates which can be accommodated in this system is in no way limited since the buoyant force which must be countered is the nutrient liquid flow velocity. The magnitude of the flow velocity can be varied through a desired range by varying the cross-sectional diameters and the aspect ratio of those diameters as necessary. The relative centrifugal field in this case is close to 1× g (that provided by the earth's gravitational field). Thus, the required applied centrifugal field, in this case, is zero.

In this embodiment, nutrient liquids, which have been pressurized and have dissolved in this liquid, the appropriate quantities of a nutrient which is gaseous at ambient pressure, are pumped into a stationary biocatalyst immobilization chamber fed by the main feed pump. The continuation of the liquid flow as it exits the biocatalyst immobilization chamber is fed through control and monitoring sensors and through a system pressure regulator which maintains the elevated hydraulic pressure of the system. The ratio of R₁ to R₂ is dependent on the desired flow velocity boundary conditions and can vary downward from 1.0 to any desired fraction thereof. R₁ is not limited in dimension: its magnitude is determined by the size of the liquid flow rate which is desired. L, the height of the immobilization chamber, is not limited in dimension: its magnitude is determined by the desired retention time of a nutrient liquid bolus as it passes through the biocatalyst immobilization chamber.

Typical biocatalyst immobilization chamber dimensions chosen include these dimensions as follows:

R₁: 5.0 cm

R₂: 5.1 cm

L:61.0 cm

A biocatalyst immobilization chamber of the above dimensions was loaded with 100 mL of 30-50 mesh peanut shell charcoal (density: ca. 3.5 gm/mL). At a liquid flow rate of 120 mL/min, an equilibrium between the flow velocity-derived buoyant forces and the intrinsic sedimentation rate of the individual charcoal particles at 1× g relative gravitational field resulted in a stable, immobilized, three-dimensional array. Note that small flow rate variations near the nominal value chosen resulted in small increases or decreases in the immobilized array density and volume, while large changes in flow rate require that R₁, R₂, and L be changed, thus requiring separate biocatalyst immobilization chamber sizes to accommodate different flow rate regimes. While the charcoal particles were found suitable for the attachment of a number of bacterial genera, the type of inert particle employed for a specific biocatalyst immobilization purpose are limited only in the compatibility with the biocatalyst and the liquid environment of the system.

There are many alternative shapes for the biocatalyst immobilization chambers which are contemplated in this invention. One such alternative embodiment is a biocatalyst immobilization chamber having its inner space in the shape of a right circular cone with a major axis which is aligned parallel to the applied centrifugal force field and which has a large diameter which is nearer to the axis of rotation than is its apex.

Another alternative embodiment is a biocatalyst immobilization chamber having its inner space in the shape of a right circular cone which has a major axis which forms an angle of between 0 and 90 degrees with the applied centrifugal force field. Also included in the present invention is a biocatalyst immobilization chamber having its inner space in the shape of a truncated right circular cone which has a major axis which is aligned parallel to the applied centrifugal force field and which has a large diameter which is nearer to the axis of rotation than is its minor diameter.

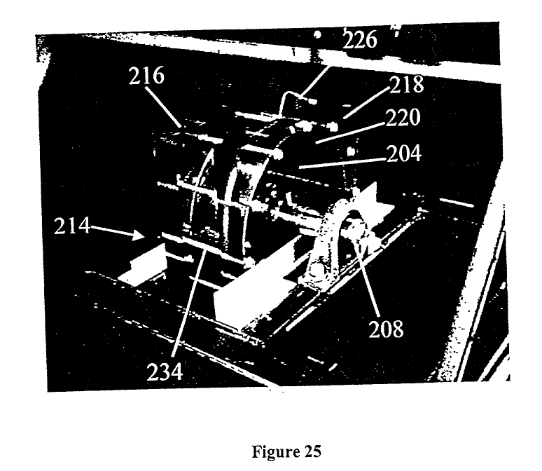

FIGS. 25-28 depict an alternative embodiment of the rotor body of this invention. Instead of forming individual chamber positioning recesses in the rotor body to hold the bioreactor chambers, each bioreactor chamber 200 is formed by a pair of rotor disks 202, 203 that form a rotor body 204. The rotor disks 202, 203 may be made from any material sufficiently strong to withstand the degree of centrifugal force contemplated by the present invention, such as aluminum, stainless steel, or plastic.

At least one face 206, 207 of each disk 202, 203 is contoured so that adjacently positioning the disks 202, 203 so that the contoured faces 206, 207 oppose each other forms a chamber 200 between the disks 202,203. The desired geometrical shape of the chamber 200 is first calculated using the methods disclosed herein. Once the desired shape is known, a face 206, 207 of each disk may be contoured and the disks 202, 203 positioned to form the desired chamber 200 between the disks 202, 203.

The disks 202, 203 are then mounted on a preferably semi-hollow rotating shaft 208. The rotor disks 202, 203 of each rotor body 204 preferably do not touch so that a gap 210 is formed between the disks 202, 203. The disks 202, 203 may be fixed in position on the rotating shaft 208 by any appropriate fixing means, such as, for example, locking collars 212. The fixing means ensure that the disks 202, 203 of the rotor body 204 remain separated by the desired distance during rotation of the shaft 208. The fixing means preferably also allow adjustment of the gap 210 between the rotor disks 202, 203. As increased volume or production capacity is needed, the diameter of the rotor disks 202, 203 and the gap 210 between the rotor disks 202, 203 may be increased.

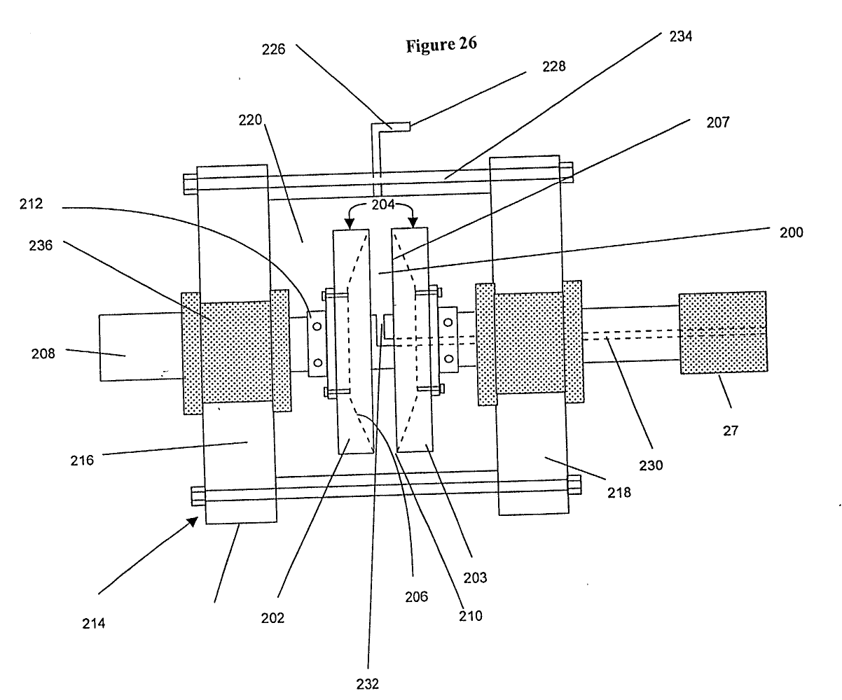

The rotor body 204 is then encased in a housing 214. The housing 214 is preferably made from materials sufficiently strong to withstand the hydraulic pressure contemplated in this invention. In one embodiment, shown in FIGS. 25-26, the housing 214 includes end plates 216, 218 mounted on the shaft 208 on either side of the rotor body 204. A cylindrical pipe 220 is positioned between the end plates 216, 218 and surrounds the rotor body 204. Studs and bolts or other fastening means 234 secure the end plates 216, 218 to each other. The force exerted by the connected end plates 216, 218 on the cylindrical pipe 220 holds the cylindrical pipe 220 in place. The end plates 216, 218, together with the cylindrical pipe 220, thereby form a hermetically-sealed housing 214 for the rotor body 204. A sealing means, such as an o-ring seal, may be located between the cylindrical pipe and the end plates and between the end plates and the shaft (236) to maintain pressure integrity within the housing 214 and minimize fluid leakage from the housing 214 into the atmosphere. While FIGS. 25-26 only illustrate one rotor body 204 encased in the housing 214, as increased volume or production capacity is needed, the distance between the end plates 216, 218 may be adjusted to accommodate additional rotor bodies 204 and thereby more chambers 200.

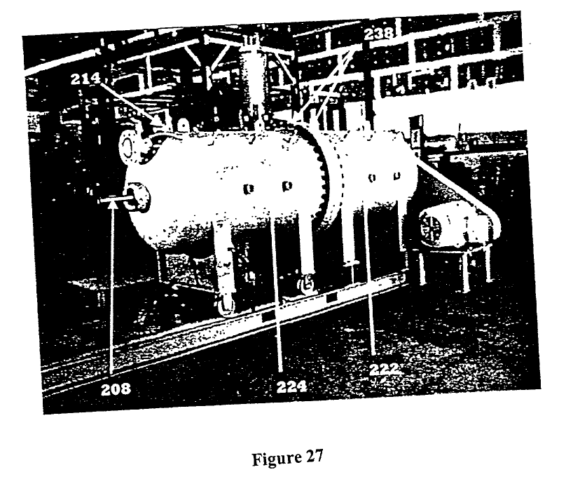

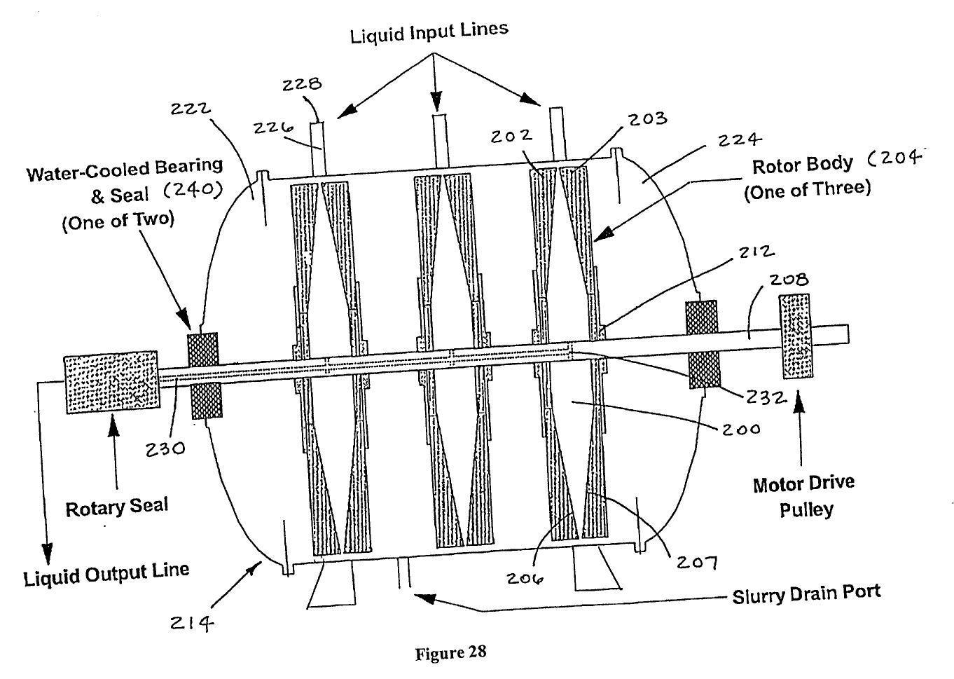

In an alternative embodiment, shown in FIGS. 27-28, the housing 214 is a capsule-like structure formed preferably by two dome-like ends 222, 224 positioned around the rotor bodies 204 mounted on the shaft 208. The dome-like ends 222, 224 are secured to each other by, for example, bolts 238, to form a closed housing and sealing means 240 are preferably positioned at the interface of the dome-like ends and the shaft to maintain pressure integrity within the housing and minimize fluid leakage from the housing into the atmosphere. As shown in FIG. 28, the housing 214 may encase multiple rotor bodies 204.

In the embodiments disclosed in FIGS. 25-28, nutrient liquids and other fluids enter the housing through fluid input tubes 226 that penetrate the housing 214 to project the fluid into the chambers 200 of the rotor bodies 204. Proper sealing means are preferably used at the interface of the housing 214 and the fluid input tubes 226 and at the distal end 228 of the fluid input tubes 226 to maintain hermetical integrity.

As illustrated in FIG. 28, a fluid output tube 230 is positioned along at least a portion of the length of the shaft 208. The fluid output tube 230 communicates with a liquid output mechanical end-face seal 27, as previously disclosed and described in relation to another embodiment. Passages 232 connect the fluid output tube 230 to the chambers 200. Fluid from the chambers 200 travels along the passages 232 and is carried out of the housing 214 by the fluid output tube 230.

In use, small quantities of the living cells or subcellular biocatalysts in a nutrient medium are introduced through the fluid input tubes into the chambers and the housing. The rotating shaft rotates at a relatively low revolutions per minute (r.p.m.) to stir the mixture and allow the cells to grow. The rotating shaft is then activated to rotate at a significantly higher rpm. The resultant increased centrifugal force forces the cells from the chambers and into the enclosed space of the housing. Nutrient liquids are then introduced into the chambers and the housing through the fluid input tubes and carry the cells back into the chamber. The inflow of nutrient fluid into the chamber counterbalances the centrifugal force exerted on the cells to capture and immobilize the cells within the chamber, while the liquid medium is able to flow out of the chamber through the fluid output tube of the rotating shaft.

The process of this invention is directed toward the immobilization of biocatalysts such as micro-organisms and eukaryotic cells, their subcellular organelles, and natural or artificial aggregates of such biocatalysts. Thus, the process system must be capable of immobilizing fairly light particles. It is known that the sedimentation rates of such particles due to gravity range from ca. 0.01 mm/min for small bacteria to 0.1 mm/min for small animal cells to more than 10.0 mm/min for thick-walled micro-organisms (such as yeasts) and biocatalytic aggregates such as bead-immobilized cells. We have analyzed the performance characteristics of the centrifugal bioreactor system of this invention using the dimensional configurations outlined above and present these results below.

A continuum of liquid flow rates and rotor speeds can be utilized which result in the immobilization of particles of an intrinsic Sedimentation Rate (SR) of 0.001 mm/min, a value smaller by a factor of ten than any we have measured for any tested micro-organism. Note that, even at a flow rate of 10 mL/min, the rotor speed required to maintain immobilization is a physically reasonable value and that the maximum centrifugal force (RCF) required is ca. 9400× g, a value well within the physical limits of average quality centrifugal systems. The corresponding profile for particles of a Sedimentation Rate (SR) of 0.01 mm/min, a value near that exhibited by typical representative bacteria. Again, a continuum of values will satisfy the immobilization conditions. Thus for example, if a flow rate of 2.0 mL/min is required to adequately nutrition a particular sized three-dimensional array of “bacteria A,” a rotor speed near 1200 rpm will suffice, while a required flow rate of 8.0 mL/min necessitates a rotor speed near 2500 rpm. Note that the heavier particles of SR=0.01 mm/min require only a modest maximal centrifugal force of ca. 1000× g at a flow rate of 10.0 mL/min.

There is also a continuum of liquid flow rates and rotor speeds which result in the immobilization of particles comparable to larger micro-organisms or small animal cells (for example, mammalian erythrocytes) of an intrinsic Sedimentation Rate (SR) of 0.1 mm/min. The corresponding values for the immobilization of more typical animal cells (ca. 30 μm diameter; SR=1.0 mm/min), while there are a continuum of values which provide for the immobilization of large dense cells, such as eukaryotic yeasts (SR=10 mm/min). The maximum rotor speeds and maximal centrifugal forces required in this flow rate range decrease as the intrinsic particle Sedimentation Rate (SR) due to gravity increases. Thus, for a flow rate of 10.0 mL/min, a three-dimensional array of average-sized animal cells requires only a relative centrifugal force of ca. 10× g to provide immobilization.

Even if the liquid flow rates required to nutrition such immobilized “beds” of particles (example bed volume=56 mL) is increased ten-fold, the maximal centrifugal forces and rotor speeds required are technically unremarkable. Note that, in the case of “animal cells” (SR=1.0 mm/min) a flow rate of 100 mL/min represents a flow of 6.0 L/hr, a flow obviously larger than that required to adequately nutrition such a three-dimensional array of cells under any imaginable conditions.

An alternative embodiment is described below. It is contemplated that the current invention includes this embodiment and all alterations in mechanical details that do not significantly alter the design. Minor modifications are included in this invention.

The embodiment is a cruciform configuration that is easily manufactured. The cell culture chamber(s) comprise a cap of a desired sector shape, preferably spherical. In a preferred embodiment, the supply liquid flow comes from an internal supply pipe, impinges on the inner surface of the cell chamber cap, and returns via a common return volume, and exits through the return pipe. This design eliminates external plumbing.

It is contemplated by the present invention that the centrifugal fermentation device may be of any size, depending on the application desired. For example, the device may be three inches in diameter for small scale applications or may be six feet in diameter for large scale diameters. The present invention contemplates all possible sizes for devices, and is not limited by these disclosed ranges.

The chamber caps may be attached by any methods known to those skilled in the art including, but not limited to, screw attachment. The chamber caps may or may not be detachable from the rest of the device. The shape of the chamber caps is determined by the particular application in which the device is employed. In a preferred embodiment, the chamber cap is a part of an assembly that screws into the cruciform structure. In an alternative embodiment, the chamber cap is made as one piece with the chamber. he liquid inlet and outlet can be on the same side in a dual rotary seal, thus allowing direct drive on the opposite side trunnions or shaft. The fluid may also flow in pipes or conduits within the trunnions. The trunnion is preferably a driven trunnion that is driven by any means known to those skilled in the art, including but not limited to direct gearing or belts.

While it is generally obvious that the effect of immobilizing a population of, for example, bacteria in a flowing liquid will not lead to cellular damage as a result of the flow of liquid past the surface of such cells (since many micro-organisms possess extracellular “sheaths” which protect their plasma membranes from liquid shear forces), it is less obvious whether delicate animal cells (which do not possess such extracellular protection) would remain viable under these conditions. However, the maximum Relative Centrifugal Force (RCF) required to maintain an average-sized animal cell immobile in a liquid flow of 10 mL/min is ca. 10× g. Even if this flow is raised to a level decidedly well above any anticipated nutritional need (100 mL/min), the maximum RCF required is only ca. 100× g. It should be remembered that the immobilization of such a cell in a flowing liquid is the mathematical equivalent of moving the cell through a stationary liquid. Thus, since the conventional laboratory sedimentation of animal cells through liquid media at RCF's of more than 100× g is an unremarkable phenomenon, it is unlikely that the shear forces acting on such cells in the process of this invention will cause any damage to their plasma membranes. This assertion is supported by the operating characteristics of a related device, the Beckman JE-5.0 Centrifugal Elutriation System, from which viable animal cells have been successfully recovered after exposure to flow rates and RCF's greatly in excess of those proposed herein for the process of this invention.

With the present invention, it is possible to immobilize three-dimensional arrays of biologically-significant particles and to adequately nutrition the immobilized particles with a completely liquid flow. In particular, for the small scale prototypic centrifugal process outlined above, the required centrifugal forces and liquid flow rates are not unusual and present no novel problems such as, for example, requiring unreasonably high rotational speeds or flow rates. Further, it has been demonstrated that there is a wide range of paired flow rate and angular velocity values which maintain the immobilization of three-dimensional arrays of such particles.

The fact that there is a wide range of flow rates and corresponding rotational speeds which can be used to immobilize such arrays of particles has, however, a wider significance. Using conventional culture methodology, the major problem encountered in large-scale culture is the inability to adequately nutrition dense masses of metabolically-active biological units. In the case of conventional mammalian cell culture for example, an average cell density of more than 1×10⁶ cells/mL is rarely achieved for prolonged time periods for this reason. Similarly, bacterial cell densities between 1×10⁷ and 1×10⁹ cells/mL are rarely exceeded in mass culture by conventional methods for this same reason. Using the methodology of the process of this invention, as cell density and effective “bed” volume increases (either from cellular proliferation or bioreactor loading), the increased nutritional requirements of larger or more dense cultures can be met by increasing input liquid flow while simultaneously increasing the size of the applied centrifugal field. Using the process of this invention, it is possible to easily maintain mammalian cell cultures at concentrations two powers of ten greater than conventional, with bacterial cell densities approaching between 1×10¹⁰ and 1×10¹¹ cells/mL equally realizable.

Similarly, for dense cultures of aerobic organisms, the conventional problem of adequate delivery of optimal dissolved oxygen to the culture is easily solved using the process of this invention. Since it is possible to dissolve molecular oxygen in typical culture media at concentrations of more than 100 mM (using a hydraulic pressure of ca. 1500 psig) the problem of the delivery of optimal dissolved oxygen, for any imaginable dense culture, is solved simply by adjusting the system hydraulic pressure to a value which will maintain the solubility of the desired concentration of oxygen. The ability to maintain dissolved oxygen concentration at optimal levels results in greatly increased production efficiency. As has been noted by many researchers, the inability to achieve cellular production efficiencies near those observed in vivo is a major disadvantage of conventional animal culture techniques (The Scientist, 8, #22, pg. 16, Nov. 14, 1994).

The ability to achieve near-normal aerobic efficiency in dense culture has another, less obvious, advantage; the generation of heat. Instead of requiring expensive energy input to bring the liquid cellular environment to an optimal temperature, it is likely that the pumped liquid of the process of this invention will have to be delivered to the cellular environment at reduced temperatures in order to carry away excess metabolic heat.

Another important advantage of the process of this invention is the relative invariance of the chemical composition of the liquid environment in which the three-dimensional arrays of biocatalysts are immobilized. Since the arrays are continually presented with fresh, optimal liquid nutrient input and since these arrays are continually drained by the continuance of the process flow, the chemical composition of the cellular environment will be completely invariant in time. There will be shallow chemical gradients of nutrients, product(s), and metabolites across the radial length of these arrays, but since the radial length is the shortest dimension of the array, these gradients will be minimal and can be easily compensated for by tailoring the media composition. Thus, for example, a pH change across the array depth can be compensated for with minimal buffering while input nutrient gradients across the array depth can be similarly compensated for.

The most important advantage of the process of the present invention, however, is the fact that metabolic waste products will be continually removed from the cellular environments by the liquid process flow. Since it has been suggested that the inability to remove metabolic wastes and the inability to continually remove desired products from the cellular environment is a major factor in lowered per-cell productivity, it is likely that the utilization of the process of this invention will markedly increase general cellular productivity.

The chemical composition of optimal input liquid nutrient media to immobilized populations of biocatalysts in the process of this invention will be quite different from that of conventional nutrient media. In particular, the optimal media composition in this process will be that which can be completely consumed in one pass through the bioreactor chamber. Typical nutrient media contain a mix of as many as thirty or more nutrient chemicals, all of which are present in amounts which greatly exceed the nutritional needs of the biocatalysts. This is because the nutrient media must sustain their metabolic processes for as long as 100 hours in some cases. Similarly, conventional media contain concentrations of pH buffer compounds and indicators and hormonal stimuli (fetal sera and/or cytokines, etc.) in amounts which greatly exceed the immediate needs of the biocatalysts. In the process of this invention, the input liquid medium can be tailored to contain those concentrations of nutrients and stimulants which are directly required by the immediate metabolism of the immobilized biocatalysts. Ideally, the outflowing liquid which exits the bioreactor would be completely devoid of nutrients and contain only salts, metabolic wastes, and product molecules. The present invention makes it possible to tailor the input media in order to maintain an immobilized cellular population in a nutritional state which either promotes or inhibits cellular proliferation. It is highly unlikely that a nutritional mix which is optimal for cellular division is optimal for the production of biochemicals by cells at rest in the cell cycle.

The liquid medium used in the present invention may be any formulation known to those skilled in the art or may include specific individual components which are necessary for the biocatalyst of interest. The kinds of media may include, but are not limited to, a nutrient medium, a balanced salt solution, or a medium containing one or more organic solvents. The medium may contain dissolved gases for growth of the biocatalyst under anaerobic or aerobic conditions. The medium may be formulated so that the biocatalyst product or mobile biocatalysts found in the medium are more easily isolated.

Another less obvious implication of the utility of this process methodology is the effect of scaling. In some of the embodiments of the present invention, the total volume capacity of the four-bioreactor rotor is ca. 224 mL and 170 mL. Note, however, that as the radius of the rotor is increased, the volume capacity of the system goes up as the cube of the radius. A rotor with a radius of 1.5 meters would have a volume capacity of ca. 120 liters. Further, since the average density of culture is roughly 100 times that of conventional culture methods, the equivalent culture volume is proportionally larger. Thus, a centrifugal fermentation unit with a rotor radius of 1.5 m is roughly equivalent to a 12,000 liter fermentation using current technology.

Finally, it should be noted that there is an additional advantage in scale in the use of the process of this invention. As a consequence of the fact that relative centrifugal force is directly proportional to the rotor radius but is also directly proportional to the square of the angular velocity, the rotational speeds required to maintain a desired relative centrifugal force decrease as the rotor radius is increased. While the rotational speed required to maintain a RCF=100× g is ca. 810 rpm for a rotor with a radius of 18 cm, this required rotational speed drops to less than 300 rpm when the rotational radius is increased to 1.5 m. This is more than a 50% lowering in the speed of rotation.

While it is obvious that scale-up of this process will have value in industrial production facilities, it should be noted that a miniature embodiment of the Centrifugal Fermentation Process could be valuable in the analytical study of the “metabolic physiology” of small homogeneous populations of a particular cell type. To our knowledge, the exact nutritional requirements for maximal proliferation of, for example, a bacterial population are unknown—and could be rapidly and easily determined by perturbation of the composition of the nutritional liquid input to an immobilized test population while measuring some output parameter indicative of growth. Similarly, while it is desirable to know exactly what nutritional mix is optimal for cellular production of a biological product (a nutritional mix which is highly unlikely to be identical to that which maximizes proliferation), such parameters are, again, unknown. We believe that small-scale versions of the process of this invention could be advantageously utilized in advancing “analytical microbiology” or “analytical cell biology” in a fashion heretofore impossible to perform.

The present invention may also be used for the continuous production of biological products which are secreted or otherwise released into the out-flowing liquid stream. Thus, for example, one might utilize this process for the continual harvest of product(s) which are released from an immobilized micro-organism population whose growth rate (and death rate) have been nutritionally manipulated to maintain a steady state immobilized “bed volume”. Such a process could run, theoretically, forever. Similarly, the immobilization of secretory animal cell populations would result in continual outflow of liquid enriched in the desired product(s).

The present invention is also extremely useful in the creation of non-secreted products (such as the cytosolic accumulation of protein in genetically-engineered E. coli). If an immobilized cell population is maintained in the bioreactor system outlined above, but under conditions of excess nutritional input, then the population will quickly grow to an enlarged bed size which will continually “leak” excess cells into the out-flowing liquid stream. Thus, the process of this invention can be operated as a “production cow.” That is, the present invention can be used as a continual incubator for the production and outflow of mature cells which are rich in the desired product. Downstream isolation and disruption of the out-flowing cell stream to capture the product of interest would then follow conventional product purification methods.

The process of this invention offers the possibility of continual, serial interconversion of bio-organic substrates through several intermediate steps by two or more separate animal cell populations or micro-organism populations. As a consequence of the ability of the process of this invention to completely immobilize biocatalyst populations while continually flowing a liquid stream into and out of the immobilized population, it now becomes possible to serially connect separate, disparate immobilized populations into one flowing process stream with the assurance that there will be no cross-contamination of one population with the other. To accomplish this, several of the devices described herein are connected in series so that materials flow from one device into another device and then into the following device and so on. A biochemical substrate, which is provided as a dissolved nutrient in the primary media reservoir, is converted into an intermediate “product A” by its passage through the biocatalyst population immobilized in a centrifuge and first rotor and is then further converted into a “product B” by passage through a biocatalyst population immobilized in the centrifuge and second rotor. Furthermore, it is possible to change the composition of the liquid nutritional feedstock between the two immobilized populations since neither centrifuge/rotor combination is constrained to operate at the same flow rate and angular velocity as the other. Thus, the liquid flow into the centrifuge and the second rotor may be modified by means of an additional pump supplying necessary nutrients from media reservoir; the total flow per unit time through the centrifuge and the second rotor is simply higher than that through the centrifuge and the first rotor.

A commercially-valuable example of the utility of a serial conversion process of this type is the biological production of acetic acid. Anaerobic bioconversion of glucose into ethanol by an immobilized population of a yeast such as Saccharomyces cerevisiae in the centrifuge and the first rotor could be followed by aerobic conversion of ethanol to acetic acid by an immobilized population of the bacterium Acetobacter acetii located in the centrifuge and the second rotor. This would require that dissolved oxygen and supplemental nutrients be provided via media reservoir.

Similarly, if a process flow scheme demanded that total flow volume per unit time through specific centrifugal bioreactor units be reduced, then a series of identical centrifugal bioreactor units could be connected in parallel to the process stream flow, with the resultant individual flow volume per unit time thereby reduced to the fractional flow through each unit. In this case, the devices of the present invention would be connected in a parallel arrangement.

The microbial organisms which may be used in the present invention include, but are not limited to, dried cells or wet cells harvested from broth by centrifugation or filtration. These microbial cells are classified into the following groups: bacteria, actinomycetes, fungi, yeast, and algae. Bacteria of the first group, belonging to Class Shizomycetes taxonomically, are Genera Pseudomonas, Acetobacter, Gluconobacter, Bacillus, Corynebacterium, Lactobacillus, Leuconostoc, Streptococcus, Clostridium, Brevibacterium, Arthrobacter, or Erwinia, etc. (see R. E. Buchran and N. E. Gibbons, Bergey's Manual of Determinative Bacteriology, 8th ed., (1974), Williams and Wilkins Co.). Actinomycetes of the second group, belonging to Class Shizomycetes taxonomically, are Genera Streptomyces, Nocardia, or Mycobacterium, etc. (see R. E. Buchran and N. E. Gibbons, Bergey's Manual of Determinative Bacteriology, 8th ed., (1974), Williams and Wilkins Co.). Fungi of the third group, belonging to Classes Phycomycetes, Ascomycetes, Fungi imperfecti, and Bacidiomycetes taxonomically, are Genera Mucor, Rhizopus, Aspergillus, Penicillium, Monascus, or Neurosporium, etc. (see J. A. von Ark, “The Genera of Fungi Sporulating in Pure Culture”, in Illustrated Genera of Imperfect Fungi, 3rd ed., V. von J. Cramer, H. L. Barnett, and B. B. Hunter, eds. (1970), Burgess Co.). Yeasts of the fourth group, belonging to Class Ascomycetes taxonomically, are Genera Saccharomyces, Zygosaccharomyces, Pichia, Hansenula, Candida, Torulopsis, Rhodotorula, Kloechera, etc. (see J. Lodder, The Yeasts: A Taxonomic Study, 2nd ed., (1970), North-Holland). Algae of the fifth group include green algae belonging to Genera Chlorella and Scedesmus and blue-green algae belonging to Genus Spirulina (see H. Tamiya, Studies on Microalgae and Photosynthetic Bacteria, (1963) Univ. Tokyo Press). It is to be understood that the foregoing listing of micro-organisms is meant to be merely representative of the types of micro-organisms that can be used in the fermentation process according to the present invention.

The culture process of the present invention is also adaptable to plant or animal cells which can be grown either in monolayers or in suspension culture. The cell types include, but are not limited to, primary and secondary cell cultures, and diploid or heteroploid cell lines. Other cells which can be employed for the purpose of virus propagation and harvest are also suitable. Cells such as hybridomas, neoplastic cells, and transformed and untransformed cell lines are also suitable. Primary cultures taken from embryonic, adult, or tumorous tissues, as well as cells of established cell lines can also be employed. Examples of typical such cells include, but are not limited to, primary rhesus monkey kidney cells (MK-2), baby hamster kidney cells (BHK21), pig kidney cells (IBRS2), embryonic rabbit kidney cells, mouse embryo fibroblasts, mouse renal adenocarcinoma cells (RAG), mouse medullary tumor cells (MPC-11), mouse-mouse hybridoma cells (I-15 2F9), human diploid fibroblast cells (FS-4 or AG 1523), human liver adenocarcinoma cells (SK-HEP-1), normal human lymphocytic cells, normal human lung embryo fibroblasts (HEL 299), WI 38 or WI 26 human embryonic lung fibroblasts, HEP No. 2 human epidermoid carcinoma cells, HeLa cervical carcinoma cells, primary and secondary chick fibroblasts, and various cell types transformed with, for example, SV-40 or polyoma viruses (WI 38 VA 13, WI 26 VA 4, TCMK-1, SV3T3, etc.). Other suitable established cell lines employable in the method of the present invention will be apparent to the person of ordinary skill in the art.

The products that can be obtained by practicing the present invention are any metabolic product that is the result of the culturing of a cell, either eukaryotic or prokaryotic; a cell subcellular organelle or component, such as mitochondria, nuclei, lysozomes, endoplasmic reticulum, golgi bodies, peroxisomes, or plasma membranes or combinations thereof, or an enzyme complex, either a natural complex or a synthetic complex, i.e., a plurality of enzymes complexed together to obtain a desired product.

One of the advantages of the present invention is the ability to produce a desired chemical from a cell without having to go through the laborious process of isolating the gene for the chemical and then inserting the gene into a suitable host cell, so that the cell (and thus the chemical) can be produced in commercial quantities. The present invention may be used to directly culture, in high-density, a mammalian cell that is known to produce a desired chemical. By doing this, the present invention may be used to produce large quantities of the desired chemical.

Products that can be produced according the present invention include, but are not limited to, immunomodulators, such as interferons, interleukins, growth factors, such as erythropoietin; monoclonal antibodies; antibiotics from micro-organisms; coagulation proteins, such as Factor VIII; fibrinolytic proteins, such as tissue plasminogen activator and plasminogen activator inhibitors; angiogenic proteins; and hormones, such as growth hormone, prolactin, glucagon, and insulin.

The term “culture medium” includes any medium for the optimal growth of microbial, plant, or animal cells or any medium for enzyme reactions including, but not limited to, enzyme substrates, cofactors, buffers, and the like necessary for the optimal reaction of the enzyme or enzyme system of choice. Suitable culture media for cell growth will contain assimilable sources of nitrogen, carbon, and inorganic salts, and may also contain buffers, indicators, or antibiotics.

Any culture medium known to be optimal for the culture of microorganisms, cells, or biocatalysts may be used in the present invention. While such media are generally aqueous in nature for the culture of living organisms, organic solvents or miscible combinations of water and organic solvents, such as dimethylformamide, methanol, diethyl ether and the like, may be employed in those processes for which they are proved efficacious, such as those bioconversions in which immobilized biocatalysts are employed. Passage of the liquid media through the process system may be either one-pass or the liquid flow may be recycled through the system for higher efficiency of conversion of substrate to product. Desired nutrients and stimulatory chemicals may be introduced into the process flow, either via the low pressure nutrient supply or via injection into the process flow upstream of the cell chamber.

It will be appreciated that the present invention is adaptable to any of the well-known tissue culture media including, but not limited to, Basal Medium Eagle's (BME), Eagle's Minimum Essential Medium (MEM), Dulbecco's Modified Eagle's Medium (DMEM), Ventrex Medium, Roswell Park Medium (RPMI 1640), Medium 199, Ham's F-10, Iscove's Modified Dulbecco Medium, phosphate buffered salts medium (PBS), and Earle's or Hank's Balanced Salt Solution (BSS) fortified with various nutrients. These are commercially-available tissue culture media and are described in detail by H. J. Morton(1970) In Vitro 6, 89-108. These conventional culture media contain known essential amino acids, mineral salts, vitamins, and carbohydrates. They are also frequently fortified with hormones such as insulin, and mammalian sera, including, but not limited to, bovine calf serum as well as bacteriostatic and fungistatic antibiotics.

Although cell growth or cell respiration within the biocatalyst immobilization chamber cannot be directly visualized, such metabolism may be readily monitored by the chemical sensing of substrate depletion, dissolved oxygen content, carbon dioxide production, or the like. Thus, for example in the case of a fermentation of a species of Saccharomyces cerevisiae, inoculation of the biocatalyst immobilization chamber with a small starter population of cells can be followed by an aerobic fermentation regime in which glucose depletion, dissolved oxygen depletion, and carbon dioxide production across the biocatalyst immobilization chamber are measured either chemically or via appropriate sensing electrodes. Thus, cell replication can be allowed to proceed until an optimal cell bed size is reached. Withdrawal of dissolved oxygen input at this time causes the immobilized yeast cells to shift into anaerobic fermentation of glucose with a resultant production of ethanol, a process which can likewise be monitored chemically.

Similarly, without any process modification, the process of the present invention can be utilized as a bioreactor for immobilized chemical catalysts, enzymes or enzyme systems. In such a process, a catalyst, an enzyme or an enzyme system is chemically immobilized on a solid support including, but not limited to, diatomaceous earth, silica, alumina, ceramic beads, charcoal, or polymeric or glass beads which are then introduced into the biocatalyst immobilization chamber. The reaction medium, either aqueous, organic, or mixed aqueous and organic solvents, flows through the process system and through the three-dimensional array of solid supports within the bioreactor. The catalyst, enzyme, or enzyme system converts a reactant in the process flow medium into the desired product or products. Similarly, in other applications, either cells or cell components including, but not limited to, vectors, plasmids, or nucleic acid sequences (RNA or DNA) or the like may be immobilized on a solid support matrix and confined for similar utilization in converting an introduced reactant into a desired product.

Commercial application of the present invention can be in the production of medically-relevant, cellularly-derived molecules including, but not limited to, anti-tumor factors, hormones, therapeutic enzymes, viral antigens, antibiotics and interferons. Examples of possible product molecules which might be advantageously prepared using the method of the present invention include, but are not limited to, bovine growth hormone, prolactin, and human growth hormone from pituitary cells, plasminogen activator from kidney cells, hepatitis-A antigen from cultured liver cells, viral vaccines and antibodies from hybridoma cells, insulin, angiogenisis factors, fibronectin, HCG, lymphokines, IgG, etc. Other products will be apparent to a person of ordinary skill in the art. The increase in emitted greenhouse gases as a result of industrial growth and its putative effect on global warming is of worldwide concern. While many physical and chemical processes designed to remove gases from exhaust have been proposed, none are financially feasible. On the other hand microbial assimilation of aqueous gases, such as carbon dioxide, would be much cheaper and simpler than current remediation techniques, the central drawback to its usage has been the impossibility of economically processing large volumes. The high flow rates which would be required would “wash out” the desired microbial population well before the desired bioremediation is performed. Microbial and algal populations are capable of direct assimilation of aqueous gases, such as carbon oxides (CO₂ and CO). Further, it has been amply demonstrated that virtually all terrestrial, as well as many marine microorganisms, exist in nature by attachment to a solid support through the agency of either homogeneous or heterogeneous biofilms. The present invention comprises bioremediation processes that exploit these microbial characteristics to remove gases, such as carbon dioxide and monoxide, from gas sources, such as flue gas emissions, smokestacks and automobiles.

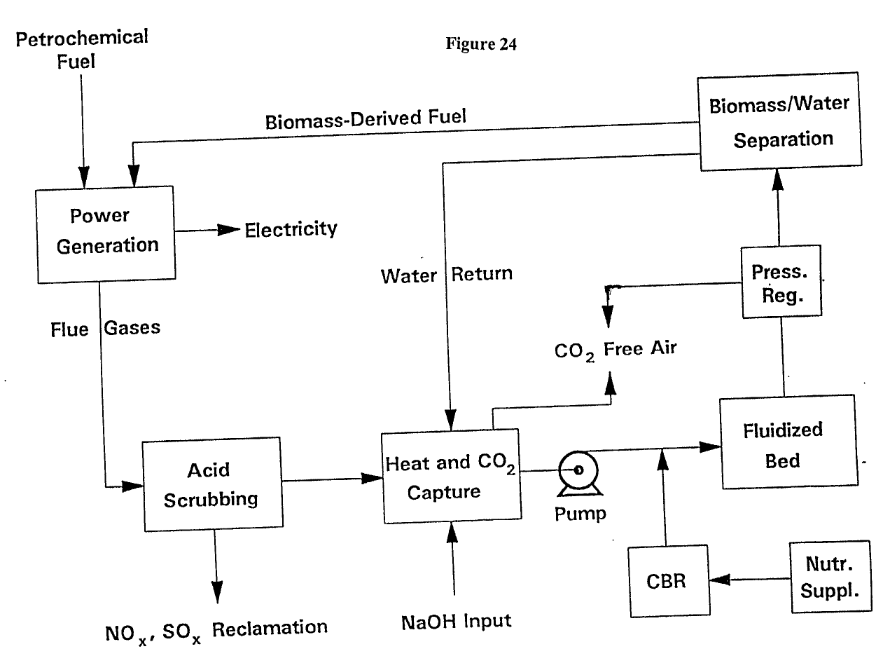

In one embodiment of the present invention, a microbial population, either homo- or heterogeneous, is immobilized on a solid support by the formation of biofilms. These solid supports are placed in an apparatus of the present invention, preferably in the arrangement of FIG. 24. The size and density of the solid support as well as the chamber dimensions are chosen to allow the system pump to achieve the desired throughput flow rate without the generation of excess liquid flow shear force on the microorganisms immobilized by the biofilm. Since it is essential that the pumped system has only two phases (liquid and solid), the pumped system is maintained at hydraulic pressures above ambient by means of a pressure regulator downstream of the chamber. Nutrient minerals and organics are supplied to the chamber under pressure, preferably by a centrifugal fermentation unit (CBR) which also serves to re-charge the biofilm-immobilized microbial population with additional desired microbes. For example, flue gas emissions which have been “scrubbed” of their sulfur- and nitrogen-containing components are stripped of their carbon dioxide contents by the dissolving of this gas into strong base or by gas separation, compression, and solubilization. The aqueous solution thus obtained is pumped into the chamber of microorganisms by the system pump. The essence of this process is the capture of flue gas carbon dioxide into biomass. Thus the downstream “output” of the chamber will be excess biomass which could easily be captured, dried, and re-used as fuel.

Another method of the present invention comprises methods, compositions and devices for the isolation of metals. Microbial populations are capable of either adsorbing, absorbing, or metabolizing a wide range of organic or inorganic compounds. Further, it has been demonstrated that terrestrial, as well as many marine microorganisms exist in nature by attachment to a solid support through the agency of either homogeneous or heterogeneous biofilms. The present invention is directed to providing microorganisms with a surface material for attachment and such surface also provides a substrate for activity by the microorganism. The substrate is acted on by the microorganisms and as a part of that activity, components of the surface material are released and thus isolated.

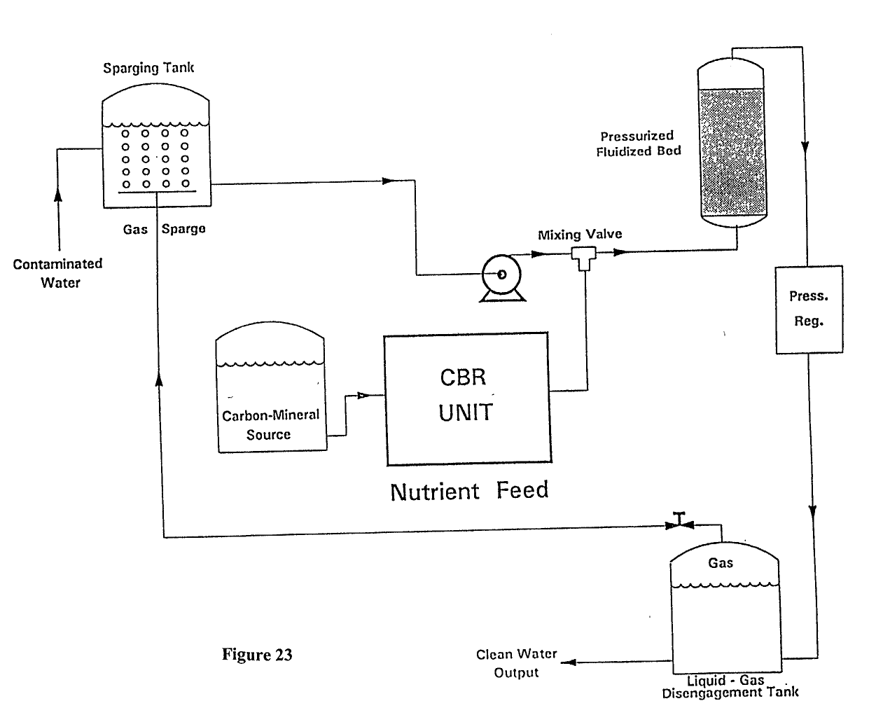

Another embodiment of the present invention comprises inert particles as the surface material that are used in a device such as shown in FIG. 23. The microorganisms are added to the device, and there the microorganism attach to the inert particles. The microorganisms act upon the inert partides. This activity may cause chemical or physical changes, or both, to the inert particles. As a product of this activity, a metal is released. Preferably, the metal is not acted upon by the microorganism. Such metals include, but are not limited to, gold, platinum, copper and silver. Any metal, that is part of an ore composition, either chemically bound or physically trapped within the ore composition, is contemplated by the present invention. While it is known that microorganisms can act on inert particles to release metals, there has not been a process that easily allows for the growth and maintenance of such microbial colonies that are adequate to release efficient amounts of metal. The high flow rates that are required in some systems wash out the desired microbial population well before they can perform the desired activities. It is contemplated that the current invention includes this embodiment and all alterations in mechanical details that do not significantly alter the design. Minor modifications are included in this invention. Microorganisms include, but are not limited to, bacteria, viruses, fingi, algae, yeasts, protozoa, worms, spirochetes, single-celled and multi-celled organisms that are either procaryotes or eucaroytes that are known to those skilled in the art. Additionally, biocatalysts are included in this method.

In a preferred embodiment, a microbial population, either homogeneous or heterogeneous, is immobilized on a solid support. Though not wishing to be bound by any particular theory, it is thought that such attachment is by the formation of biofilms. These solid supports are placed into a chamber as shown in FIG. 23, where the desired aqueous liquid flow is produced. The size and density of the solid support as well as the chamber dimensions are chosen to allow the system pump to achieve the desired throughput flow rate without the generation of excess liquid flow shear force on the immobilized biofilm. Since it is essential that the pumped system has only two phases (liquid and solid), the pumped system is maintained at hydraulic pressures above ambient by means of a pressure regulator, preferably downstream of the chamber. Nutrient minerals, organics, and dissolved gases are supplied to the chamber, under pressure, by a centrifugal fermentation unit (CBR) which also serves to recharge the biofilm-immobilized microbial population with additional desired microbes. Where advantageous, input solution may be de-oxygenated by a gas sparging system available as a result of pressure release downstream of the output pressure regulator.

In another embodiment of the present invention, the inert particles used as the surface material are made of iron pyrite, FeS₂. The iron pyrite ore is finely ground and added to the chamber. Bacteria that can metabolize the ore are added.

In one composition, the bacteria include various species selected from the Thiobacillis ferrioxidans sp. group. The bacteria initiate chemolithotropic processes which are oxygen dependent. Though not wishing to be bound by any particular theory, it is believed that the bacteria convert the FeS₂ into FeSO₄, ferrous sulfate. During this conversion, metals that are incorporated into the ore are released. One such preferred metal is gold. A constant slurry of ore is fed into the chamber to replenish the surface material that is being degraded or acted upon. The gold is easily retrieved from the chamber.

Use of other types of bacteria for isolation of metals is contemplated by the present invention. The present invention is not limited by the described microorganisms or surface materials. Any microorganisms capable of acting or degrading substrates that then release metals are contemplated by the present invention.

In a further embodiment of the present invention, the Centrifugal BioReactor (CBR) units are employed in a system for removing contaminants such as ether-based compounds from contaminated fluids, including liquid, gas, and solids, such as soil. In other words, remediation of the ether-based compounds occurs. Examples of ether-based compounds that can be degraded are tertiary butyl ethers of the type utilized as gasoline oxygenates, for example, methyl tert-butyl ether, ethyl tert-butyl ether, and methyl tert-amyl ether and also ether solvents, for example, tetrahydrofuran.

In one embodiment, the CBR units maintain and culture populations of biocatalysts, such as, propane-oxidizing microorganisms or isopropanol; oxidizing microorganisms, capable of consuming ether-based compounds. Examples of fluids for which use of this invention are contemplated include, but are not limited to, soil remediation, and remediation of wastewater, groundwater, and the like. Embodiments of CBR units useful are those as described above and in the cross-referenced patents and patent applications listed herein.

As mentioned above, the present invention can also be used to provide effective bioremediation of ether-based compounds from contaminated soil. In one embodiment, the ether-based compounds are removed from the contaminated site and contacted with biocatalysts, such as, propane-oxidizing microorganisms and/or isopropanol-oxidizing microorganisms. The biocatalysts convert the contaminants, such as the ether-based compounds, to innocuous compounds that are environmentally acceptable, or simply environmentally acceptable compounds. Examples of such environmentally acceptable compounds are gasoline oxygenates and ether solvents. Examples of ether-based compounds that can be degraded are tertiary butyl ethers of the type utilized as gasoline oxygenates, for example, methyl tert-butyl ether, ethyl tert-butyl ether, and methyl tert-amyl ether and also ether solvents, such as tetrahydrofuran. It should be understood that the present invention has applicability to the treatment of other ether-based contaminants.

Biocatalysts that can be used in the present invention include any microorganisms that can be immobilized in the chambers of the present invention for contacting and degrading ether-based compounds. Biocatalysts include microorganisms and eukaryotic or prokaryotic cells, their subcellular structures and organelles, and natural or artificial aggregates of such biocatalysts. Examples of biocatalysts or microorganisms that can degrade ether-based compounds include, but are not limited to, Pseudomonas putida (PRS2000), a soil bacterium, BC-1 disclosed in U.S. Pat. Nos. 5,902,734, 5,811,010 and 5,750,364 and Mycobacterium vaccae JOB5, ENV420, ENV421, or ENV425, each disclosed in U.S. Pat. No. 5,814,514. Each of the above-listed bacterial strains, as well as other strains that may be used in the present invention, are available from the American Type Culture Collection (ATCC).

In another embodiment, an apparatus useful in the present invention may be placed near a large body of water contaminated with ether-based compounds, such as, MTBE. The contaminated water is drawn into the apparatus and treated using the methods of the present invention and returned as clean water into the hydrologic cycle.

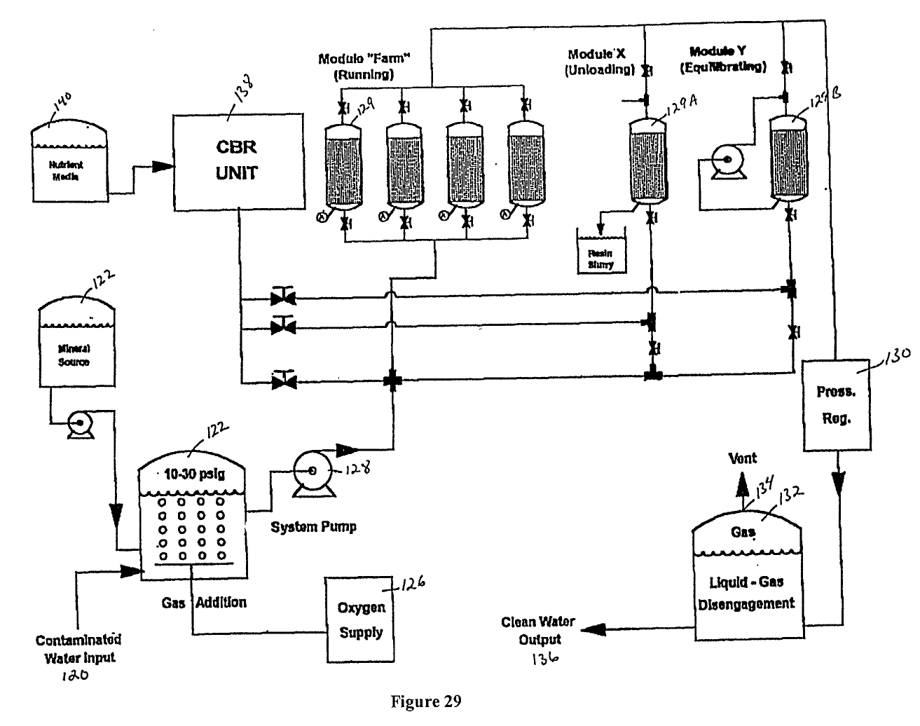

Turning to FIG. 29, a schematic is shown of an embodiment of the present invention useful for removal of contaminants from fluids. Contaminated fluid 120, for instance water contaminated with ether-based compounds, is positioned in a holding tank 122 wherein supplements 124 (as described in more detail below) may be added and oxygen under pressure 126 is applied to the contaminated fluid. The then pressurized contaminated fluid 120 is conveyed, for instance by a pump 128 through chambers 129, wherein the chambers contain biocatalysts useful in substantially degrading, removing, and/or remediating the contaminants from the contaminated fluid 120. The contaminated fluid 120 is then pumped through a pressure regulator 130 and pumped through another tank 132 wherein gas is vented 134 and “clean” fluid is discharged 136. As used herein, the term “clean fluid” means that the contaminants have been substantially removed from the effluent fluid. Also shown on the left is a CBR unit 138, used to grow replacement biocatalysts for periodic introduction into the chambers 129 or a series of CBRs. A nutrient media feeding tank 140 for the CBR unit 138 is also shown. Shown on the right are off-line chambers for unloading biocatalysts 129A and equilibrating chambers 129B before returning them on-line.

The biocatalysts may be free in solution or supported. Types of support include, but are not limited to, adsorption on granules of activated charcoal.

The present invention comprises methods of degrading contaminants wherein no other metabolic or energy sources, other than the contaminants being degraded, are provided. Additionally, the present invention comprises methods of degrading contaminants wherein supplementation is needed for the optimum growth and/or activity of the biocatalysts. Types of supplements may include, but are not limited to, media, sugars, vitamins, minerals or additional sources of carbon. Minerals for supplementing the biocatalysts include, but are not limited to, ammonium and phosphate ions.

In yet another embodiment of the present invention, an ether removal system is designed to allow high-volume fast-throughput conversion of ether-based compounds in solution to carbon dioxide gas. The system includes at least one CBR, which may be in combination with additional pressurized biocatalyst immobilization CBRs. The carbon dioxide gas produced is typically vented to the atmosphere. The CBR may be used to grow replacement biocatalysts for introduction into a series of CBR biocatalyst immobilization chambers. Each working chamber contains a biocatalyst population that must be monitored and adjusted in order to maintain the efficiency with which the ether-based compounds are consumed.

In one embodiment, a supply of contaminated fluid is collected in a tank, supplemented with a mineral additive and rendered aerobic by oxygen gas pressurization. The fluid is then pumped by the main system pump to multiple CBR chambers containing the biocatalysts, where ether-based compounds in solution are metabolized. The output of these chambers passes through a pressure-maintaining valve and into a disengagement tank where, at atmospheric pressure, gases are released.

The present invention provides many methods for optimal bioremediation. For example, the apparatuses of the present invention can maintain the size of the working biocatalyst population. One method for achieving this is by the withdrawal of an essential nutrient or mineral from, or the introduction of a growth inhibitor into the CBR. In this manner, biocatalyst overgrowth is eliminated.

Working microorganism populations often lose effectiveness over time, usually through contamination, but also by genetic drift in the population. As previously mentioned, the CBR units of the present invention can be used to “recharge” individual chambers with the desired biocatalysts. In one embodiment, the CBR unit periodically supplies a quantity of the proper biocatalysts to one or more of the CBR chambers.

Another problem seen in bioremediation systems is the contamination of the output flow with detached and potentially pathogenic microorganisms. This problem is eliminated in the present invention in several different ways. One way is by maintaining the biocatalysts within the CBR chambers due to the vector forces acting on the cells. Another method comprises operating the chambers containing the biocatalysts at increased internal hydraulic pressure, allowing excess gas to be dissolved into the liquid system and thus into the internal liquid milieu of the biocatalysts. In an apparatus in which a biocatalyst might detach, any biocatalysts that do detach experience a rapid decompression downstream of the output pressure regulator and are quantitatively reduced to innocuous fragments in the system output flow (i.e., the pressure change causes the biocatalysts to explode).

All patents, patent applications and publications cited herein are hereby incorporated by reference in their entireties.

The invention is further illustrated by the following examples, which are not to be construed in any way as imposing limitations upon the scope thereof. On the contrary, it is to be clearly understood that resort may be had to various other embodiments, modifications, and equivalents thereof, which, after reading the description herein, may suggest themselves to those skilled in the art without departing from the spirit of the present invention.

### EXAMPLE 1

Removing NOX from the Gases Emitted by an 800 Watt Electric Generator.

A scrubber has been constructed to treat the contaminants of the combustion gas produced by an 800 watt power gasoline-fired generator. The NO component in NOX is 12 times more insoluble than SO₂ in water, thus being the critical factor in the conversion process.

These tests demonstrate the efficacy of the process and correlate the time required for a reaction between O₃ and NO. For purposes of the experiment, two (2) separate scrubber towers were employed. The first scrubber tower introduced and mixed the ozone with the combustion gas at different locations. The second scrubber tower saturated the treated combustion gas mixture with water to cause the NOX pollutants to go into solution.

Each location for injection in Tower No. 1 is directly related to residence time preceding contact with the water spray.

Variables measured and observed during the experiment were:

Time

Fuel Rate (measured as level change in the fuel tank)

Flue gas temperature from the engine

Flue gas temperature leaving Tower No. 1

Flue Gas temperature leaving Tower No. 2 (Stack)

Gas analysis entering Tower No. 1 (CO, CO2, NOX, O₂, N₂)

Gas analysis leaving Tower No. 1 (CO, CO₂, NOX, O₂, N₂)

Gas analysis leaving Tower No. 2 (CO, CO₂, NOX, O₂, N₂)

Spray water temperature entering Tower No. 2

Water temperature leaving Tower No. 2

Volume rate of flow O₃ (Ozone)

Volume rate of flow of water

Measurements were conducted with laboratory grade temperature indicators. Gas analysis was performed using a Tempest 100 portable orsat with an integral printer. The calibration of this instrument was verified with a standard nitrogen sample prior to starting the experiment.

Each variable was modified in a series of tests conducted over a three (3) day period. Fuel flow rate and power generation level was held constant throughout. Portable analyzers were used to measure any remaining NOX levels.

The test results confirmed the theory, delivering NOX reductions between 70 to 75%, with relatively low flow rates of ozone and water. FIGS. 8-10, described earlier in more detail, illustrate the results achieved from testing.

In FIG. 9 the percentage of NOX Reduction is plotted as a function of the location of the injection port for ozone. The data for both sets of results shows strong consistency with the highest reductions occurring when the ozone was injected through the port 32 (D) closest to the outlet 34, which had the lowest residence time. This appears to be related to the molecular instability of ozone, as a free radical.

FIG. 10 shows data from tests for the percentage of NOX Reduction conducted using both compressed air (Material A) and compressed oxygen (Material B) as the feed source for the ozone generator. The results using compressed air show a similar pattern. Inadequate gas flow through the unit will cause the NOX readings to be erroneous.

### EXAMPLE 2

Removing SOX from Gases Emitted by a 273 MW Power Plant.

Extending this technology to a 273 MW or larger plant would involve a scale-up in the physical parameters of the system design, but without any significant change to the base technology or design concept. The level of NOX reduction is projected to remain in the 70% to 75% range, demonstrated by the initial testing reported under Example 1.

For a 273 MW coal-fired plant, the key operating parameters would typically be:

Current Technology

Feedwater Flow to the Boiler=1,920,414 lbs./hr.

Steam Flow to the Turbine=1,901,400 lbs./hr.

Gas Flow from the Combustion Chamber/Boiler=2,331,690 lbs./hr.

Air Flow for Combustion=2,117,420 lbs./hr.

Plant Make-up Water=38,028 lbs./hr.

NO-SOX Process Flows

Air to Ozone Generator<40,000 lbs./hr

Ozone Generated for Injection<4,000 lbs./hr

Recirculated Water Injection to Spray Tower<650,000 lbs./hr

Make-up Water to Recirculating Water System<13,000 lbs./hr

Designing for a low gas velocity of 0.3 to 1.5 feet per second will then result in an economical configuration of diameter vs. height for the reaction chamber. For illustration purposes a 273 MW coal-fired power plant would require a reaction chamber of the following size:

Quantity of reaction chambers 2

Diameter 75

Height 75

Such chambers could be constructed of relatively inexpensive materials i.e. carbon steel plate. The gas temperature is still sufficiently elevated to prevent internal acidic corrosion from the products of combustion. The exterior surfaces would be insulated to maintain temperatures above the gas dewpoint, until the partially treated gas enters the gas scrubber. This is the normal practice utilized for the design of gas flues between an electrostatic precipitator and a wet scrubber. If desired by a power plant operator, these chambers could be constructed of Cor-ten, stainless steel, or even perhaps of high-temperature polymers.

The downstream scrubber is expected to follow current technology and design practice employed for Flue Gas Desulphurization systems, except without the use of reagents, such as limestone, lime, soda ash, or magnesium hydroxide.

The average gas velocity for this design would typically vary from 8 to 13 fps. “scrubbers which treat more than 6×10⁶ lb/h (756 kg/s) of flue gas have been built and no fundamental engineering limits to wet scrubber size have been identified.” (ref. 8)

I claim:

1. A method for removing pollutants from gases, comprising the steps of:
injecting ozone into a reaction chamber;
mixing the polluted gases with the ozone in the reaction chamber for converting the pollutants to soluble compounds; and
simultaneously reducing the temperature inside the reaction chamber and spraying water into the gases
wherein the soluble compounds are removed from the gases by going into solution in the water.

2. The method of claim 1 further comprising the step of removing the soluble compounds from the water.

3. The method of claim 1 further comprising the step of monitoring and adjusting a retention time for mixing polluted gases with ozone.

4. The method of claim 1 further comprising the step of using air and ozone in the mixing step.

5. The method of claim 2 wherein a sulfate-reducing bacteria assists in removing the soluble compounds from the water.

6. The method of claim 1 further comprising the step of converting SOX into sulfur.

7. An apparatus for removing exhaust contaminants from exhaust gas, comprising:
a chamber for mixing ozone and the exhaust gas for placing the exhaust contaminants in soluble form;
said chamber being connected to a scrubber for placing the exhaust contaminants in solution, thereby producing clean gas and contaminated water;
a stack connected to said scrubber for releasing the clean gas; and
a water treatment system connected to said scrubber for removing the contaminants from the water.

8. The apparatus of claim 7 further comprising multiple injection ports within said chamber for introducing said ozone into said chamber.

9. The apparatus of claim 7 further comprising injection means for supplying air into said chamber.

10. The apparatus of claim 7 wherein said water treatment system is capable of processing about 50,000 gallons of wastewater using a 50 gallon centrifugal bioreactor.
